(19) United States
(12) Patent Application Publication
(10) Pub. No.: US 2026/0146695 A1
(43) Pub. Date: May 28, 2026

(54) AUTOMATED NOZZLES FOR CRYOGENIC FLUID TRANSFER

(71) Applicant: Engineered Controls International, LLC, Elon, NC (US)

(72) Inventors: Kevin Jordan, Burlington, NC (US); John Grenaway, Huntersville, NC (US); Clark Ervin, Greensboro, NC (US)

(21) Appl. No.: 19/371,882

(22) Filed: Oct. 28, 2025

Related U.S. Application Data
(60) Provisional application No. 63/712,908, filed on Oct. 28, 2024.

(51) Int. Cl. F16L 37/091; F16L 37/62; F17C 5/02

(52) U.S. Cl. CPC F16L 37/091; F16L 37/62; F17C 5/02; F17C 2221/012; F17C 2223/0161; F17C 2270/0168

(57) ABSTRACT

Automated nozzles for cryogenic fluid transfer are disclosed. A nozzle includes a flow body. The nozzle includes a rotating sleeve configured to rotate about the flow body. The rotating sleeve defines cam slot(s) configured to slidably receive respective teeth of a receptacle as the rotating sleeve is rotated from an unlocked position to a locked position. The rotating sleeve defines cutouts and includes helical guide rails. Each of the helical guide rails is located at an innermost wall defining a respective one of the cutouts. The nozzle includes locking/unlocking actuators. Each of the locking/unlocking actuators includes a shaft configured to engage and push against a respective one of the helical guide rails to cause the rotating sleeve to rotate between the unlocked position and the locked position.

### CROSS-REFERENCE TO RELATED APPLICATION

This application claims the benefit of U.S. Provisional Patent Application No. 63/712,908, filed on Oct. 28, 2024, the contents of which are incorporated by reference herein in their entirety.

### TECHNICAL FIELD

This disclosure generally relates to nozzles and, more particularly, to automated nozzles for cryogenic fluid transfer.

### BACKGROUND

Receptacles are designed to receive fluid from nozzles. Receptacles transfer the received fluid into a connected storage tank. One example of a receptacle is a car gasoline port. One example of a nozzle is a gasoline dispenser at a gas station. One example of a connected storage tank is a car gas tank.

Cryogenic fluids, such as liquid hydrogen (LH2), also may be transferred between storage tanks via specialized nozzles and receptacles. For instance, a nozzle may be connected to a storage tank of a filling station for liquid hydrogen, and a receptacle may be connected to a storage rank of a vehicle that will subsequently transport the liquid hydrogen. Liquid hydrogen is stored in liquid form at cryogenic temperatures, which may make it difficult to comfortably and securely transfer between storage tanks.

### SUMMARY

An example nozzle for coupling and providing fluid to a receptacle includes a flow body. The flow body defines a chamber for fluid flow and includes a front end and a back end. A longitudinal axis extends between the front end and the back end. The nozzle includes a ring flange extending circumferentially around a portion of the flow body and fixed relative to the flow body. The nozzle includes a rotating sleeve configured to rotate about the front end of the flow body. The rotating sleeve includes a coupling end adjacent the front end of the flow body and defining one or more cam slots. The one or more cam slots are configured to slidably receive respective one or more teeth of the receptacle as the rotating sleeve is rotated from an unlocked position to a locked position. The rotating sleeve includes an actuator end adjacent the ring flange and defining a plurality of cutouts. The actuator end includes a plurality of helical guide rails. Each of the plurality of helical guide rails is located at an innermost wall defining a respective one of the plurality of cutouts. The nozzle includes a plurality of locking/unlocking actuators each of which includes an actuator housing coupled to the ring flange and a shaft extending into a respective one of the plurality of cutouts. The shaft is configured to engage and push against a respective one of the plurality of helical guide rails to cause the rotating sleeve to rotate between the unlocked position and the locked position.

### BRIEF DESCRIPTION OF THE DRAWINGS

FIG. 1 depicts an example system for transferring cryogenic fluid.

FIG. 2 depicts an example receptacle of the system of FIG. 1.

FIGS. 3-5 depict an example nozzle of the system of FIG. 1.

FIG. 6 depicts a body, ring flange, and actuators of the nozzle of FIGS. 3-5.

FIG. 7 depicts a rotating sleeve of the nozzle of FIGS. 3-5.

FIG. 8 depicts a fixed sleeve of the nozzle of FIGS. 3-5.

FIGS. 9-12 depict the nozzle of FIGS. 3-5 without the fixed sleeve of FIG. 8.

FIG. 13 depicts the nozzle of FIGS. 3-5 without a body of the fixed sleeve of FIG. 8 and with the rotating sleeve of FIG. 7 in an unlocked state.

FIG. 14 depicts the nozzle of FIGS. 3-5 without a body of the fixed sleeve of FIG. and with the rotating sleeve of FIG. 7 in a locked state.

FIG. 15 is a cross-sectional view of the receptacle of FIG. 2.

FIG. 16 is a cross-sectional view of the nozzle of FIGS. 3-5.

FIG. 17 is an expanded, cross-sectional view of a front portion of the nozzle of FIGS. 3-5.

FIG. 18 is an expanded, cross-sectional view of a back portion of the nozzle of FIGS. 3-5.

FIG. 19 is an expanded, cross-sectional view of the receptacle of FIG. 2 and a portion of the nozzle of FIGS. 3-5 in a purge state.

FIG. 20 is an expanded, cross-sectional view of the receptacle of FIG. 2 and a portion of the nozzle of FIGS. 3-5 in the locked state of FIG. 14.

FIG. 21 is a cross-sectional view of a purge inlet port of the nozzle of FIGS. 3-5.

FIG. 22 depicts an example post of the rotating sleeve of FIG. 7.

FIG. 23 further depicts the post of FIG. 22.

FIG. 24 depicts the nozzle of FIGS. 3-5 with manual handles coupled to the posts of FIG. 22.

FIGS. 25-27 depict another example nozzle of the system of FIG. 1.

FIG. 28 depicts a rotating sleeve of the nozzle of FIGS. 25-27.

FIG. 29 is a flowchart for operating the nozzle of FIGS. 3-5 and/or the nozzle of FIGS. 25-27 with the receptacle of FIG. 2.

### DETAILED DESCRIPTION OF THE DRAWINGS

The description that follows describes, illustrates and exemplifies one or more embodiments of the present invention in accordance with its principles. This description is not provided to limit the invention to the embodiments described herein, but rather to explain and teach the principles of the invention in order to enable one of ordinary skill in the art to understand these principles and, with that understanding, be able to apply them to practice not only the embodiments described herein, but also other embodiments that may come to mind in accordance with these principles. The present specification is intended to be taken as a whole and interpreted in accordance with the principles of the present invention as taught herein and understood by one of ordinary skill in the art.

The scope of the present invention is intended to cover all such embodiments that may fall within the scope of the appended claims, either literally or under the doctrine of equivalents. The specification describes exemplary embodiments which are not intended to limit the claims or the claimed inventions. Features described in the specification, but not recited in the claims, are not intended to limit the claims.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose.

Some features may be described using relative terms such as top, bottom, vertical, rightward, leftward, etc. It should be appreciated that such relative terms are only for reference with respect to the appended drawings. These relative terms are not meant to limit the disclosed embodiments.

Example nozzles and methods of use are disclosed herein for safely transferring cryogenic fluid, such as liquid hydrogen, from a storage tank to a fill tank. Each nozzle is configured to securely and sealingly couple to a receptacle, via automated mechanisms, to fluidly connect a fill tank to a storage tank in a manner that impedes cryogenic fluid from being emitted into the atmosphere.

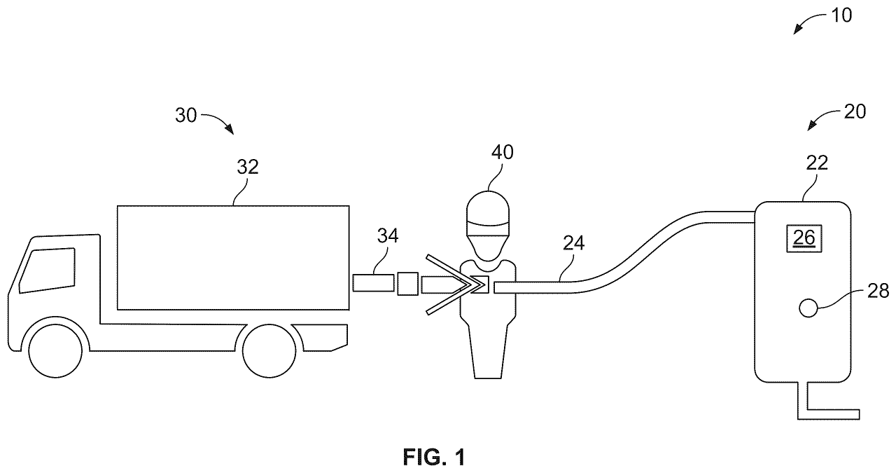

Turning to the figures, FIG. 1 illustrates an example system 10 for transferring cryogenic fluids, such as liquid hydrogen, in accordance with the teachings herein. The system 10 includes filling station 20 and vehicle 30 for transporting cryogenic fluid.

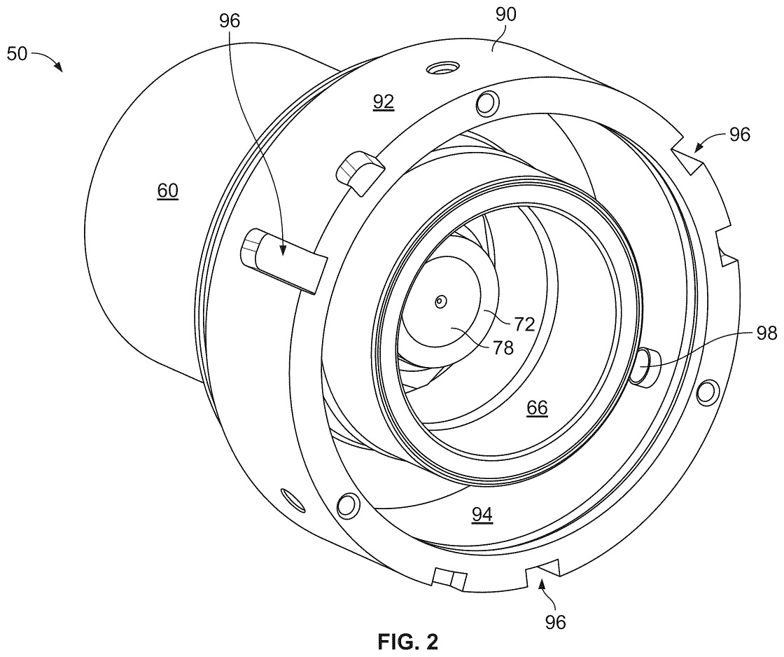

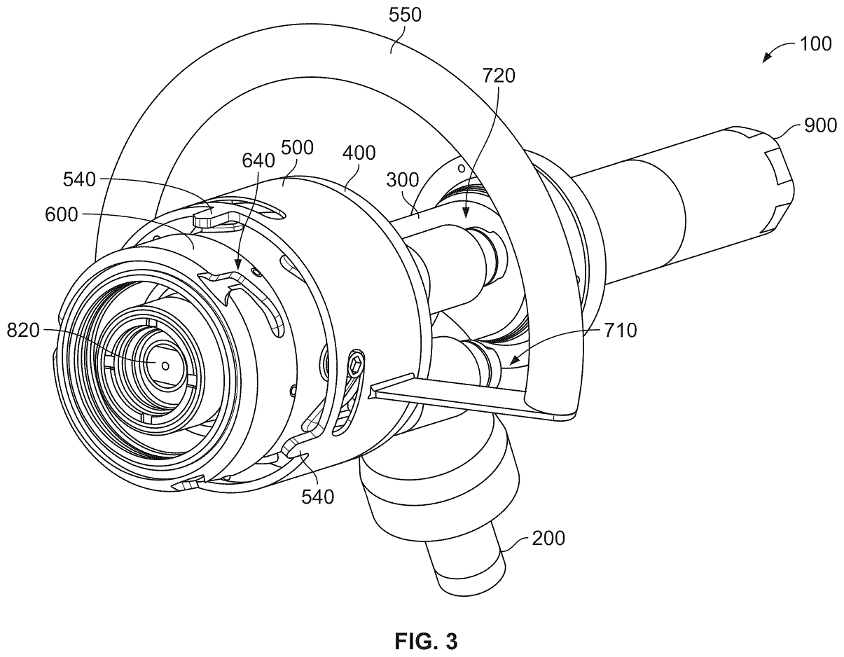

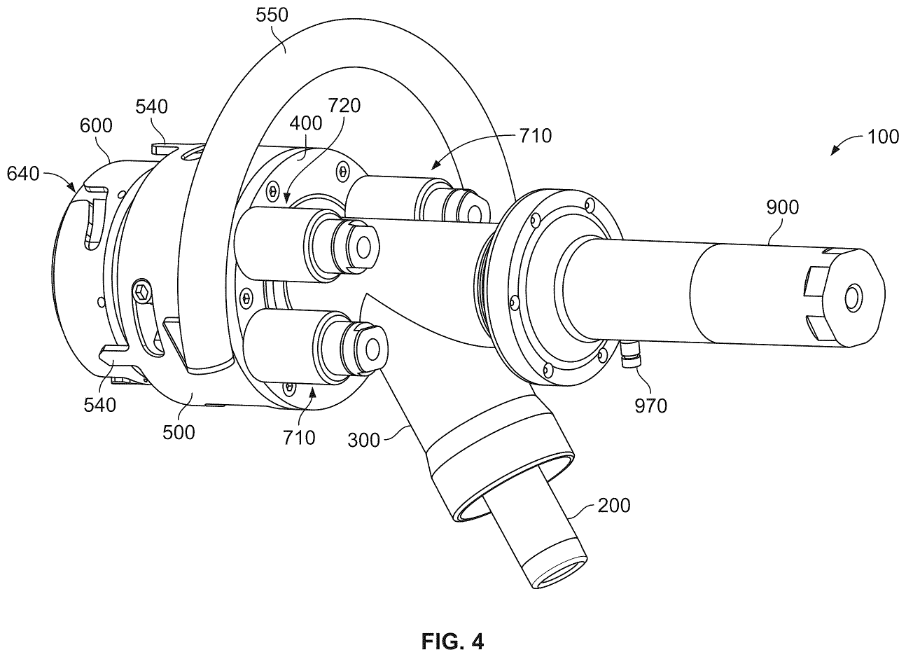

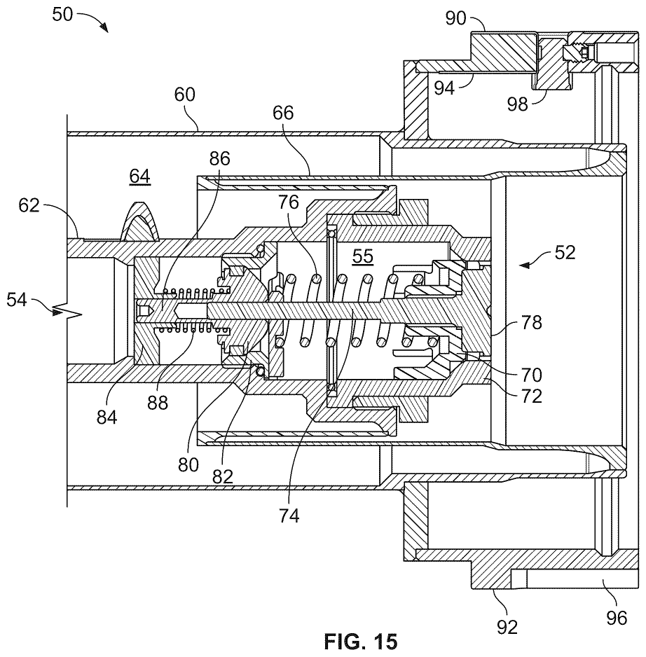

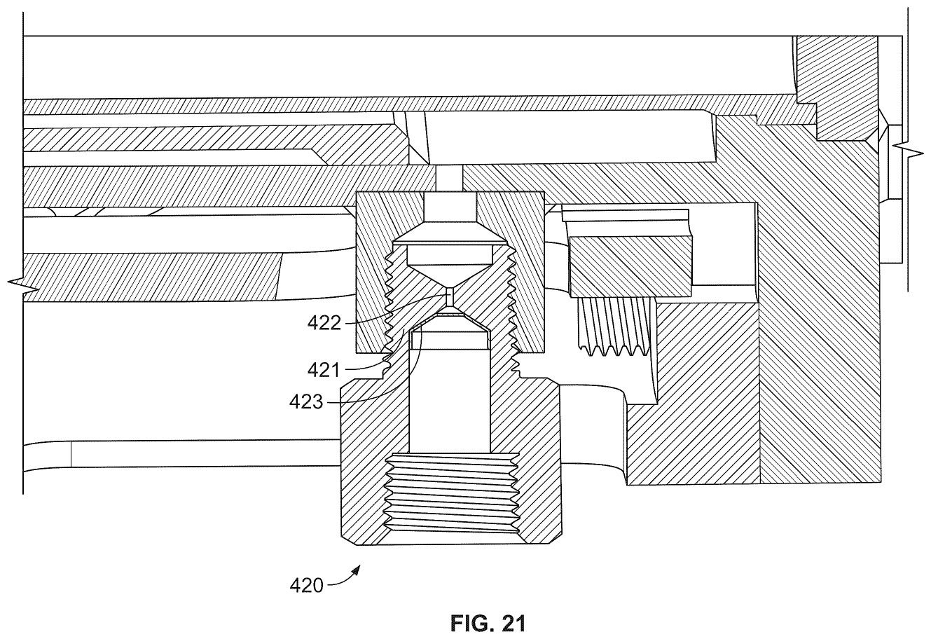

Filling station 20 of the illustrated example includes storage tank 22, hose 24 connected to and extending from storage tank 22, a nozzle (such as a nozzle 100 of FIGS. 3-5 and 16, a nozzle 1000 of FIGS. 21-23) at a distal end of hose 24, controller 26 for controlling the filling process in a safe and secure manner, and button 28. Controller 26 of filling station 20 includes hardware with circuitry to provide monitoring and control capabilities. Vehicle 30 includes fill tank 32, hose 34 connected to and extending from fill tank 32, and a receptacle (such as a receptacle 50 of FIGS. 2 and 15) at a distal end of hose 34. In other examples, the receptacle is mounted directly to fill tank 32 without an external intermediate hose.

In the illustrated example, storage tank 22 of filling station 20 is configured to store cryogenic fluid, and fill tank 32 of vehicle 30 is configured to receive the cryogenic fluid from storage tank 22 via hoses 24, 34, the nozzle, and the receptacle. In order to transfer cryogenic fluid from storage tank 22 to fill tank 32, operator 40 is to couple the nozzle to the receptacle to fluidly connect fill tank 32 to storage tank 22. Once operator 40 securely couples the nozzle to the receptacle, operator 40 initiates the transfer of cryogenic fluid from a remote location. For example, operator 40 presses button 28 at filling station 20 to instruct controller 26 to begin the filling sequence.

FIGS. 2 and 15 depict an example receptacle 50. As shown in FIG. 15, receptacle 50 includes flow body 62 and head 72 that are connected together and define chamber 55. Head 72 defines inlet 52, and flow body 62 defines outlet 54. As disclosed below in further detail, cryogenic fluid is to enter chamber 55 through inlet 52 and subsequently exit chamber 55 through outlet 54. Receptacle 50 includes poppet 70 (also referred to as “outer poppet” and “first poppet”) and poppet 80 (also referred to as “check poppet,” “inner poppet,” and “second poppet”) to control the flow of cryogenic fluid into and through chamber 55.

Receptacle 50 also includes seat 82 (also referred to as “check seat,” “inner seat,” and “second seat”), guide 84, stem 86 (also referred to as “check stem,” “inner stem,” and “second stem”), and spring 88 (also referred to as “check spring,” “inner spring,” and “second spring”). Guide 84 is fixed to flow body 62 in chamber 55 adjacent outlet 54, and seat 82 is fixed to flow body 62 in chamber 55 between guide 84 and head 72. Stem 86 slidably extends along the longitudinal axis of receptacle 50 between seat 82 and guide 84. Spring 88 extends between guide 84 and a backside of poppet 80 to bias poppet 80 toward a closed position. Poppet 80 is configured to sealingly engage seat 82 in the closed position and be disengaged from the seat 82 in an open position. Receptacle 50 includes poppet 80 to provide a seal that is redundant to that of poppet 70 in case of a leak at poppet 70, provide pressure relief to allow cryogenic fluid that is trapped between poppets 70, 80 to enter fill tank 32, and/or to trap pressure that allows a seal at poppet 80 to be replaced without having to empty the contents of fill tank 32.

Additionally, receptacle 50 includes stem 74 (also referred to as “outer stem” and “first stem”) and spring 76 (also referred to as “outer spring” and “first spring”). Stem 74 slidably extends along a longitudinal axis of receptacle 50. Poppet 70 is connected to a first, outer end of stem 74 and defines face surface 78. A second, inner end of stem 74 is nested in poppet 80 and/or stem 86 of poppet 80. Head 72 defines or forms a seat (also referred to as “outer seat” and “first seat”) for poppet 70. Spring 76 extends between seat 82 and a backside of poppet 70 to bias poppet 70 toward a closed position. Poppet 70 is configured to sealingly engage the seat of head 72 in the closed position and be disengaged from the seat of head 72 in an open position.

Receptacle 50 includes shell 60 (also referred to as “outer shell”). Insulation layer 64 is located in a gap formed between shell 60 and flow body 62. Insulation layer 64 includes a vacuum and/or insulating material disposed in a gap formed between shell 60 and flow body 62 to provide insulation between shell 60 and the extremely cold temperature of cryogenic fluid flowing through flow body 62 of receptacle 50. In the illustrated example, zig-zag walls 66 extend between and sealingly connect to shell 60 and flow body 62. Zig-zag walls 66 define insulation layer 64 with shell 60 and flow body 62. Zig-zag walls 66 extend longitudinally back-and-forth in a zig-zag pattern to form an elongated conduction path between chamber 55 and the exterior of receptacle 50 to reduce an amount of heat leak between chamber 55 and the exterior.

As shown in FIGS. 2 and 15, receptacle 50 includes outer sleeve 90 that extends circumferentially around and over a front portion of receptacle 50. Outer sleeve 90 includes outer surface 92 and inner surface 94. Outer surface 92 defines one or more axial slots 96 that extend parallel to the longitudinal axis of receptacle 50. Axial slots 96 are spaced equidistantly apart from each other about outer surface 92. Further, one or more teeth 98 (also referred to as “bearings”) extends radially inward from inner surface 94 of outer sleeve 90. Teeth 98 are spaced equidistantly apart from each other about inner surface 94. As disclosed below in greater detail, axial slots 96 are configured to receive axial pins 540 of a fixed sleeve of a nozzle (e.g., fixed sleeve 500 of nozzle 100 and/or nozzle 1000) and teeth 98 are configured to be received by cam slots 640 of a rotating sleeve of the nozzle (e.g., rotating sleeve 600 of nozzle 100 and/or rotating sleeve 1600 of nozzle 1000) to securely fasten the nozzle to receptacle 50.

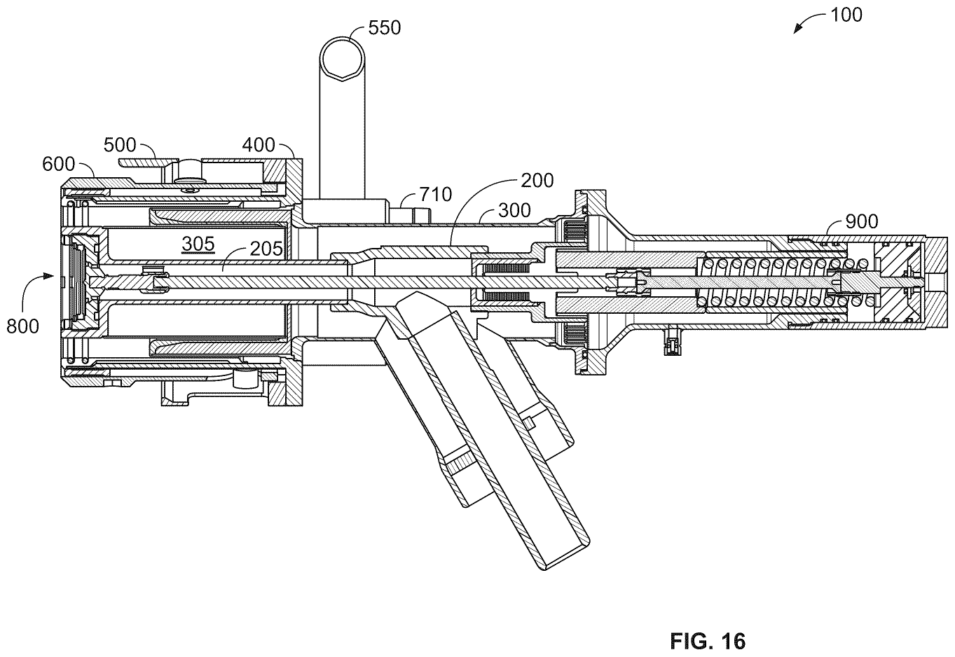

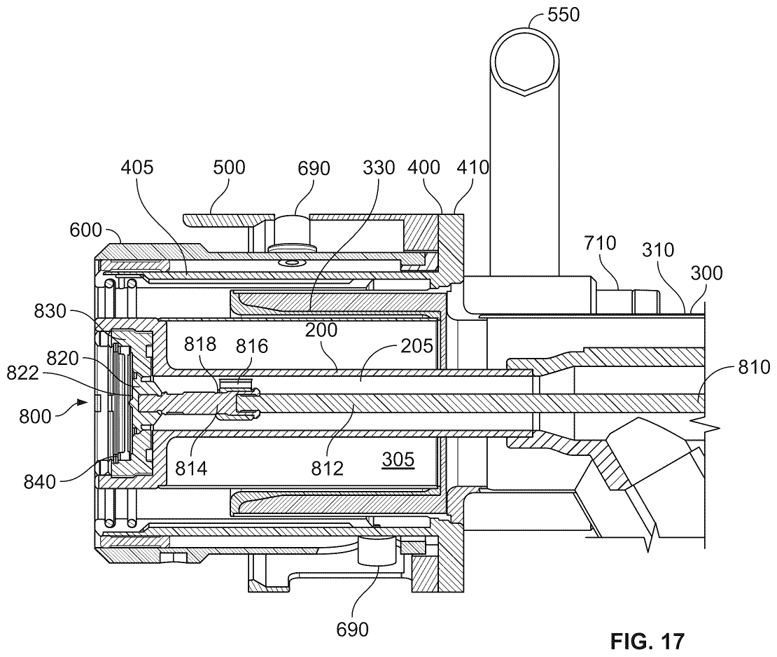

FIGS. 3-5 depict an example nozzle 100 configured to securely couple to receptacle 50, for example, to securely transfer cryogenic fluid from storage tank 22 and into fill tank 32. Nozzle 100 includes flow body 200 that defines chamber 205 (FIGS. 16-17) through which cryogenic fluid is to flow. Flow body 200 includes a front end configured to couple to receptacle 50 and a back end to which actuator 900 is secured. In the illustrated example, nozzle 100 also includes shell 300 (also referred to as “outer shell”) that extends over and covers flow body 200. Insulation layer 305 (FIGS. 16-17) is formed between flow body 200 and shell 300 and provides insulation between shell 300 and the extremely cold temperature of cryogenic fluid flowing through chamber 205 of flow body 200.

Nozzle 100 includes ring flange 400, fixed sleeve 500, and rotating sleeve 600. Ring flange 400 is fixed relative to and extends circumferentially around a portion of flow body 200. For example, ring flange 400 is fixed to shell 300 to be fixed relative to flow body 200. Rotating sleeve 600 is configured to rotate about the front end of flow body 200. As disclosed below in greater detail, nozzle 100 includes one or more locking actuators 710 to rotate rotating sleeve in a first direction and one or more unlocking actuators 720 to rotate rotating sleeve in an opposing second direction. As used herein, actuators 710 and unlocking actuators 720 are collectively referred to as “locking/unlocking actuators.” Fixed sleeve 500 (also referred to as “outer sleeve”) is fixed relative to flow body 200 and extends circumferentially around and covers a portion of rotating sleeve 600.

In operation and as detailed below in further detail, nozzle 100 is securely coupled to receptacle 50 via fixed sleeve 500; rotating sleeve 600; and actuators 710, 720 (e.g., pneumatic actuators). Fixed sleeve is configured to rotationally align nozzle 100 with receptacle 50. Locking actuators 710 then rotate rotating sleeve 600 (e.g., about 25 degrees) to lock nozzle 100 to receptacle 50. Subsequently, actuator 900 opens a flow path between nozzle 100 and receptacle 50 to commence a fill event. As used herein, a “fill event” refers to a period of time during which fluid, such as cryogenic fluid is transferred from a storage tank and into a fill tank. After the fill event has been completed, actuator 900 closes the flow path to prevent subsequent fluid flow between nozzle 100 and receptacle 50. Unlocking actuators 720 then rotate rotating sleeve 600 to unlock nozzle 100 from receptacle 50, and nozzle 100 is removed from receptacle 50.

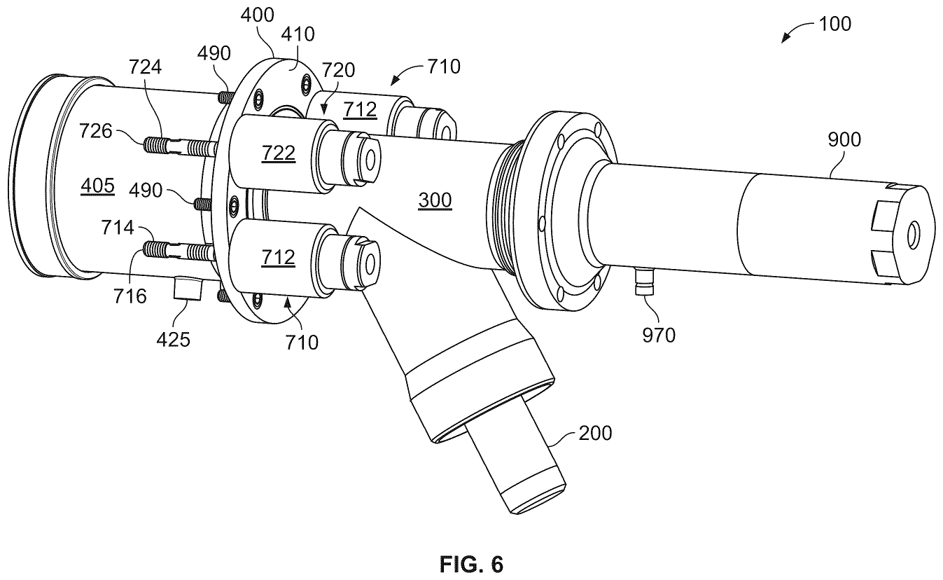

In the illustrated example, ring flange 400 is coaxial with flow body 200. That is, a center axis of ring flange 400 extends along a longitudinal axis of flow body 200 that extends between its front end and back end. As shown in FIG. 6, ring flange 400 includes axial portion 405 and radial portion 410. Axial portion 405 is coaxial with the longitudinal axis of flow body 200 and at least partially covers the front end of flow body 200. Radial portion 410 is offset from the front end of flow body 200 and extends in a direction radially outward from the longitudinal axis of flow body 200.

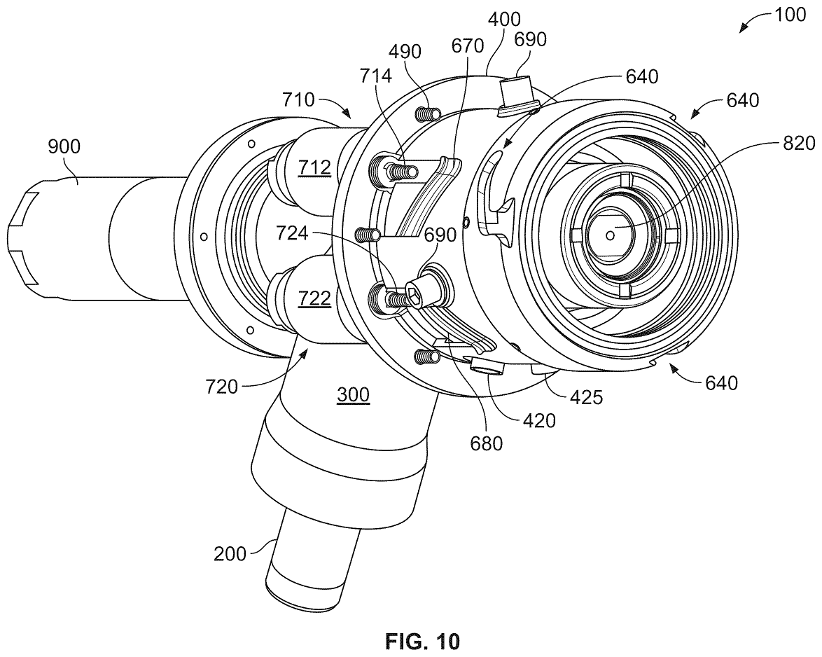

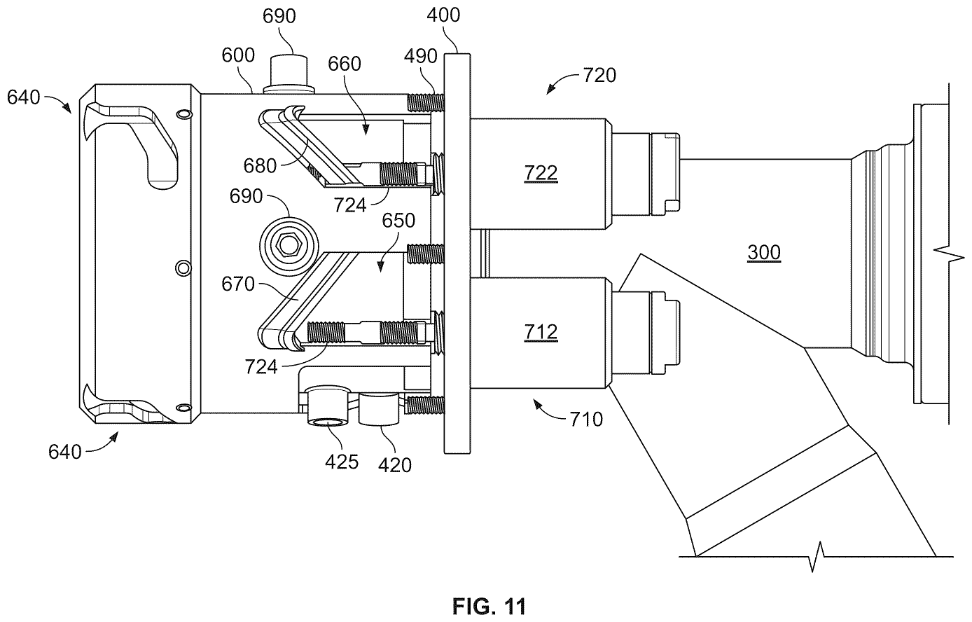

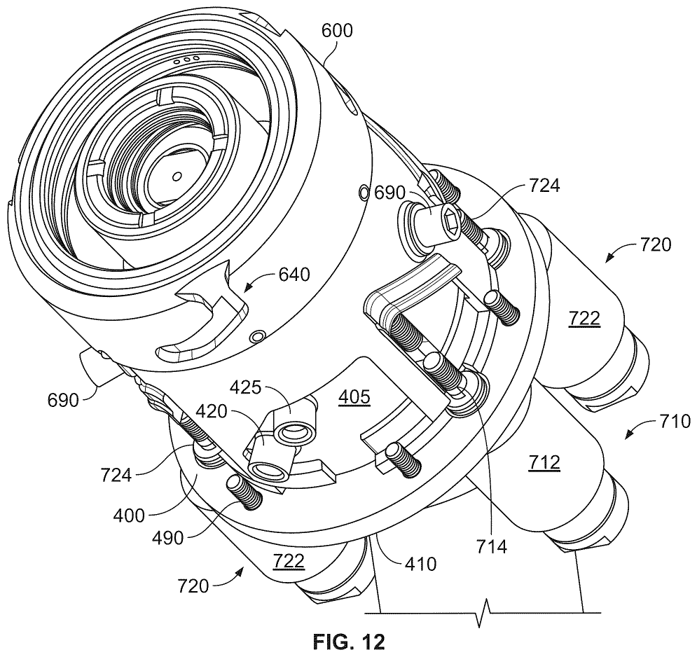

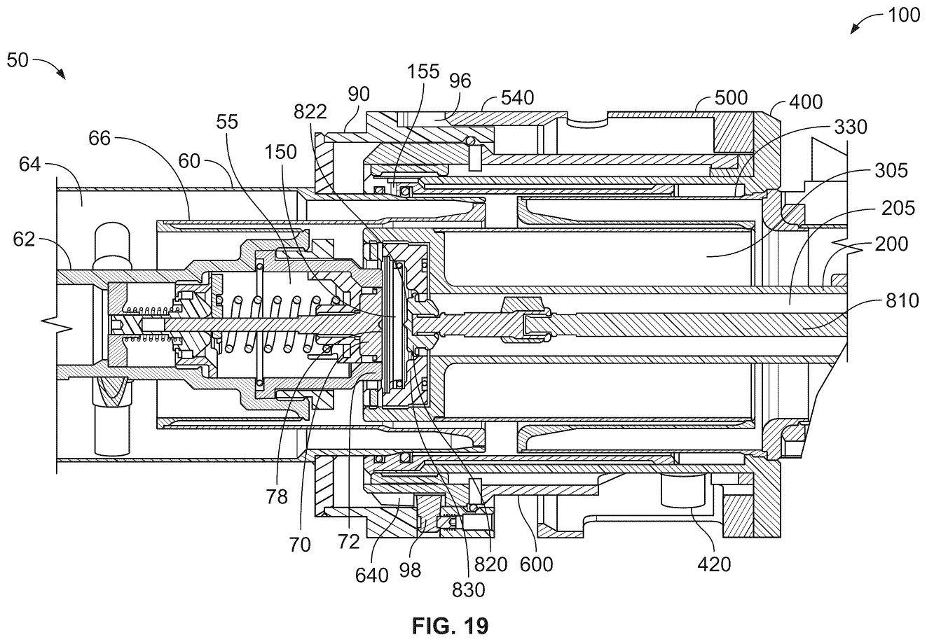

As shown in FIGS. 10-12, purge inlet port 420 and purge outlet port 425 are fixed to axial portion 405 of ring flange 400. As disclosed below in further detail, purge inlet port 420 and purge outlet port 425 are configured to fluidly connect to coupling chamber 150 via purge channel 155 (FIG. 19) formed between nozzle 100 and receptacle 50 to purge unwanted gas(es) and/or debris from coupling chamber 150 prior to a fill event. Purge inlet port 420 and purge outlet port 425 are also configured to purge coupling chamber 150 after a fill event and prior to disconnecting nozzle 100 from receptacle 50, ensure proper engagement and locking of nozzle 100, detect when a purge sequence has commenced or ended, and/or test for leakage of seal(s) and/or poppet(s) of nozzle 100 and/or receptacle 50.

Turning to FIG. 21, purge inlet port 420 includes restrictor 421 to deter coupling chamber 150 from being over-pressurized and, in turn, prevent seals in coupling chamber 150 from being dislodged and/or damaged. For example, restrictor 421 defines orifice 422 that is sized to limit a flowrate of purge gas into coupling chamber 150. As disclosed below in further detail, rotating sleeve 600 includes detents 625 that are configured to hold rotating sleeve 600 in place with respect to outer sleeve 90 of receptacle 50 in a purge state. Orifice 422 of restrictor 421 limits the flowrate of purge gas to limit pressure accumulation within coupling chamber 150 and, in turn, deter detents 625 from being dislodged due to the pressure within coupling chamber 150. Further, purge inlet port 420 includes screen 423 upstream of restrictor 421 to filter out debris from a purge gas supply and prevent any such debris from blocking orifice 422.

Returning to FIGS. 10-12, each actuator 710, 720 includes a respective housing 712, 722 (also referred to as “actuator housing”) and a respective shaft 714, 724 (also referred to as “actuator shaft”). Specifically, each locking actuator 710 includes housing 712 and shaft 714, and each unlocking actuator 720 includes housing 722 and shaft 724. Housing 712, 722 of each actuator 710, 720 is fixed to ring flange 400. In the illustrated example, housing 712, 722 of each actuator 710, 720 is coupled to radial portion 410 of ring flange 400. Actuators 710, 720 are oriented with respect to ring flange 400 and flow body 200 such that shaft 714, 724 of each actuator 710, 720 moves linearly in a direction that is parallel to the longitudinal axis of flow body 200. Further, each shaft 714, 724 includes a respective ball bearing 716, 726 at its distal end.

As disclosed below in further detail, each shaft 714, 724 is configured to push rotating sleeve 600 between its locked position and its unlocked position. Specifically, when actuated to their extended positions, shafts 714 of actuators 710 are configured to push rotating sleeve to its locked position. Conversely, when actuated to their extended positions, shafts 724 of actuators 720 are configured to push rotating sleeve 600 to its unlocked position. Ball bearings 716, 726 facilitate actuators 710, 720 in causing rotating sleeve 600 to rotate between its locked position and its unlocked position.

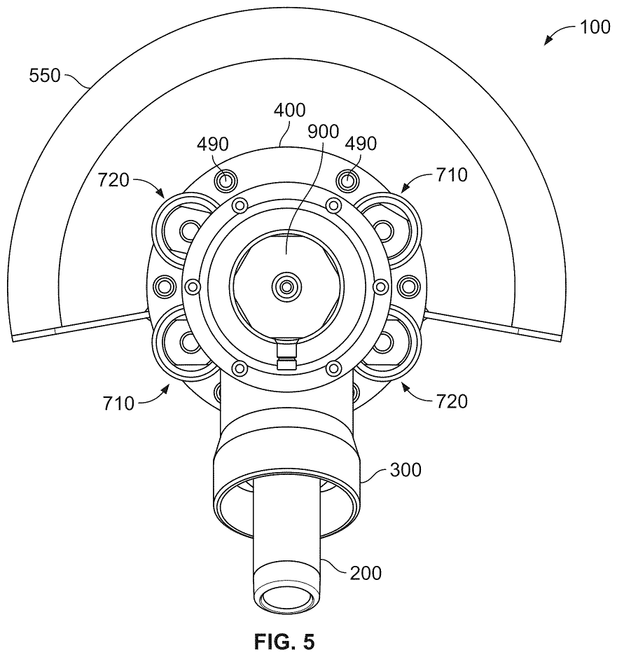

In the illustrated example, actuators 710, 720 are arranged circumferentially around ring flange 400 and are equidistantly spaced apart from each other about ring flange 400. Further, locking actuators 710 and unlocking actuators 720 are arranged in an alternating manner. For example, as shown in FIG. 5, nozzle 100 includes two opposing locking actuators 710 and two opposing unlocking actuators 720 that are spaced equidistantly from each other. Such an arrangement of actuators 710, 720 about ring flange 400 prevent actuation of actuators 710 and/or actuators 720 from causing resulting in a cocking motion that unintentionally binds rotating sleeve 600 in place.

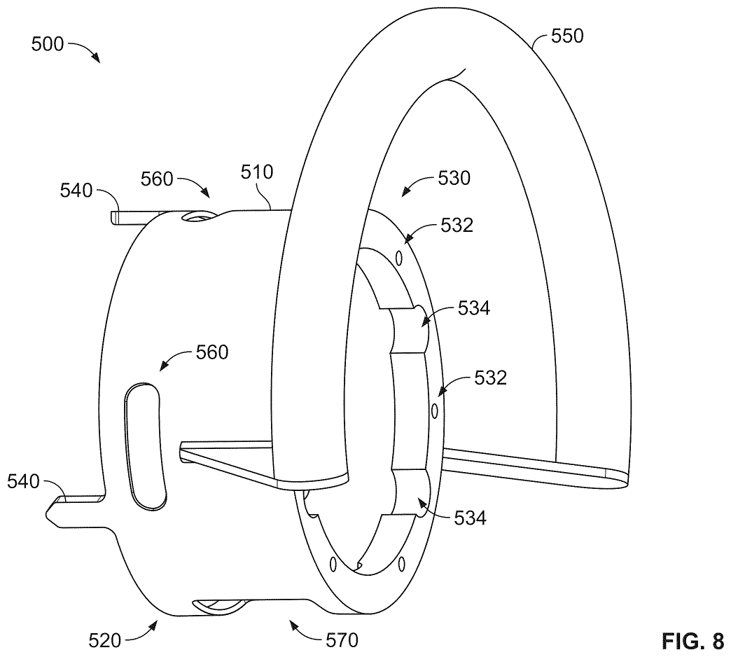

Turning to FIG. 8, fixed sleeve 500 is further depicted. Fixed sleeve 500 is fixed relative to flow body 200 via ring flange 400. Fixed sleeve 500 includes body 510 (also referred to as “sleeve body” and “fixed sleeve body”) having alignment end 520 and fixed end 530 that are opposite of each other.

In the illustrated example, body 510 defines one or more holes 532 along fixed end 530. Each hole 532 is configured to receive a respective fastener 490 (FIGS. 5 and 9-12) to couple fixed sleeve 500 to ring flange 400. Body 510 also defines one or more curved notches 534 along fixed end 530. Each actuator 710, 720 extends at least partially through a respective curved notch 534.

Fixed sleeve 500 includes one or more axial pins 540 that extend axially outward from an outer edge of alignment end 520. In the illustrated example, axial pins 540 are spaced apart from each other equidistantly along the outer edge at alignment end 520. As disclosed below in further detail, axial pins 540 are configured to be inserted into and slidably received by axial slots 96 of receptacle 50 to rotatably fix fixed sleeve 500 and, in turn, flow body 200 of nozzle 100 relative to receptacle 50. By rotatably fixing fixed nozzle 100 to receptacle 50, axial slots 96 improve alignment between seals of nozzle 100 and receptacle 50 before engagement, deter rotation of cold seal(s) of nozzle 100 and/or receptacle 50 during engagement, and/or increase an operating life of seal(s).

In the illustrated example, fixed sleeve 500 includes handle 550 that is fixed to and extends from body 510 of fixed sleeve 500. Handle 550 enables operator 40 to safely and securely handle nozzle 100 when coupling nozzle 100 to receptacle 50, holding nozzle 100 during a fill event, and/or decoupling nozzle 100 from receptacle 50.

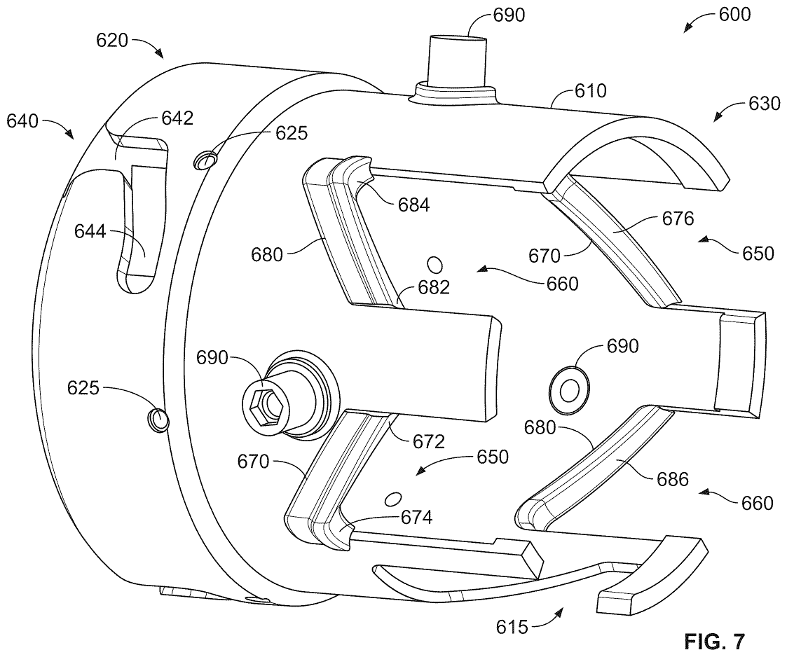

Further, body 510 of fixed sleeve 500 defines one or more slotted openings 560 and opening 570. Each slotted opening 560 extends circumferentially about fixed sleeve 500 in a direction parallel to an outer edge at alignment end 520 and/or fixed end 530 of body 510. As disclosed below in further detail, each slotted opening 560 is configured to receive a respective post 690 (FIG. 7) of rotating sleeve 600 to enable fixed sleeve 500 and, in turn, flow body 200 move axially with rotating sleeve 600 relative to receptacle 50 as rotating sleeve 600 moves in a helical motion to lock nozzle 100 to receptacle 50. Slotted openings 560 extend circumferentially along fixed sleeve 500 to prevent slotted openings 560 and posts 690 from preventing rotation of rotating sleeve 600 relative to fixed sleeve 500. Further, opening 570 is arranged to provide access to purge inlet port 420 and purge outlet port 425 (FIGS. 10-12) that are that are fixed to ring flange 400.

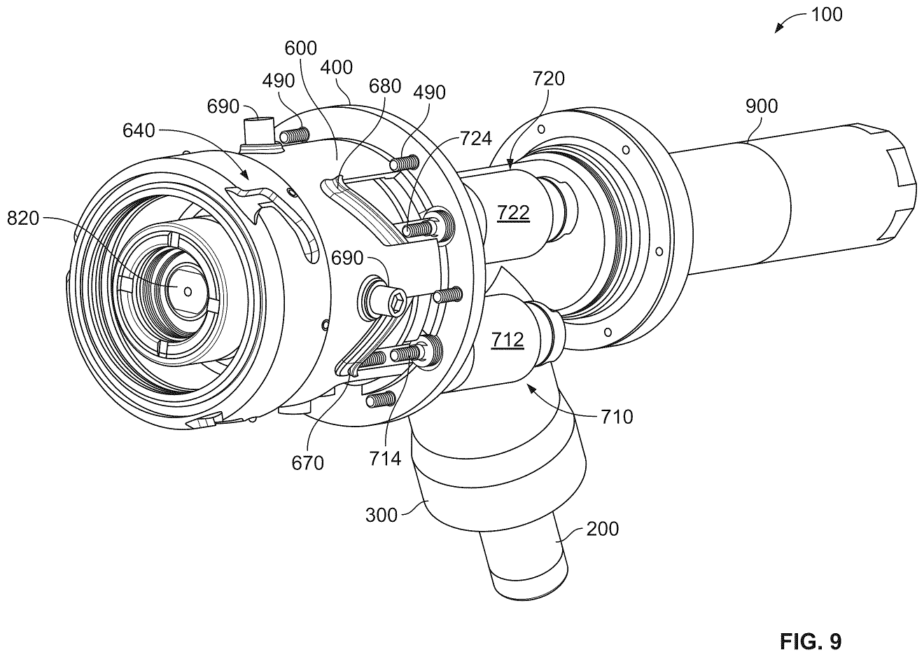

Rotating sleeve 600 is further depicted in FIG. 7. Rotating sleeve 600 includes body 610 (also referred to as “sleeve body” and “rotating sleeve body”) and has coupling end 620 and actuator end 630 that are opposite of each other. As shown in FIGS. 9-12, which depict nozzle 100 without fixed sleeve 500, coupling end 620 is adjacent the front end of flow body 200 and actuator end 630 of is adjacent radial portion 410 of ring flange 400 when nozzle 100 is assembled.

Returning to FIG. 7, body 610 defines one or more cam slots 640 along coupling end 620. In the illustrated example, axial pins 540 are spaced apart from each other equidistantly along the outer edge at alignment end 520. Each cam slot 640 has an opening that extends from an outer edge of body 610 at coupling end 620. Additionally, each cam slot 640 includes a respective front portion 642 and a respective rear portion 644. Front portion 642 of each cam slot 640 extends from the opening at the outer edge of coupling end 620 and axially along body 610 of rotating sleeve 600. Rear portion 644 of each cam slot 640 extends from an end of front portion 642 and helically along body 610 of rotating sleeve 600. That is, front portion 642 (also referred to as “axial portion”) of each cam slot 640 extends in an axial direction, and rear portion 644 (also referred to as “helical portion”) of each cam slot 640 extends in a helical direction. As disclosed below in further detail, each cam slot 640 is configured to slidably receive a respective tooth 98 of receptacle 50 as rotating sleeve 600 is rotated from its unlocked position to its locked position.

In the illustrated example, rotating sleeve 600 also includes one or more detents 625 (also referred to as “detent pins”) that are located near coupling end 620 of body 610. Each detent 625 is biased (e.g., is a spring-loaded, ball detent) to extend radially outward from body 610. Detent 625 are arranged in such a manner to hold rotating sleeve 600 in place with respect to outer sleeve 90 of receptacle 50 in a purge state, which is disclosed in further detail below. Detents 625 may also provide a tactile click to notify operator 40 that nozzle 100 is securely in the purge state.

Body 610 of rotating sleeve 600 also defines cutouts 650, 660 that are arranged circumferentially about and extend inwardly from an outer edge at actuator end 630. Each cutout 650, 660 corresponds with a respective actuator 710, 720. Specifically, in the illustrated example, each of one or more locking cutouts 650 corresponds with a respective locking actuator 710, and each of one or more unlocking cutouts 660 corresponds with a respective unlocking actuator 720.

Rotating sleeve 600 also includes guide rails 670, 680 (also referred to as “helical guide rails”). Guide rails 670, 680 may be coupled to and/or integrally formed with body 610. Each guide rail 670, 680 is located along an innermost wall defining a respective cutout 650, 660. Each guide rail 670, 680 corresponds with a respective actuator 710, 720. Specifically, in the illustrated example, each of one or more locking guide rails 670 corresponds with a respective locking actuator 710, and each of one or more unlocking guide rails 680 corresponds with a respective unlocking actuator 720.

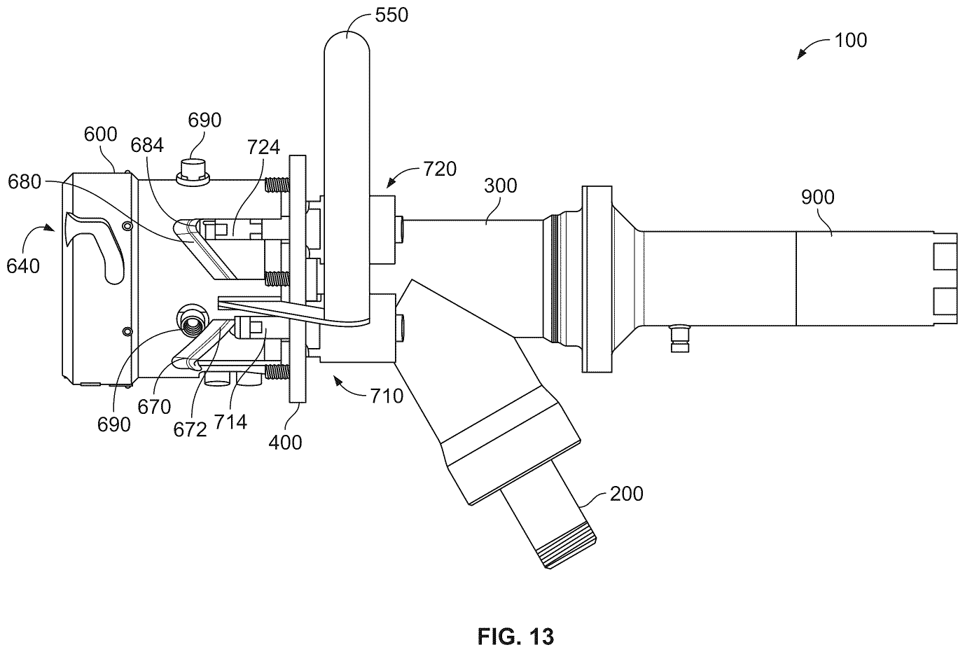

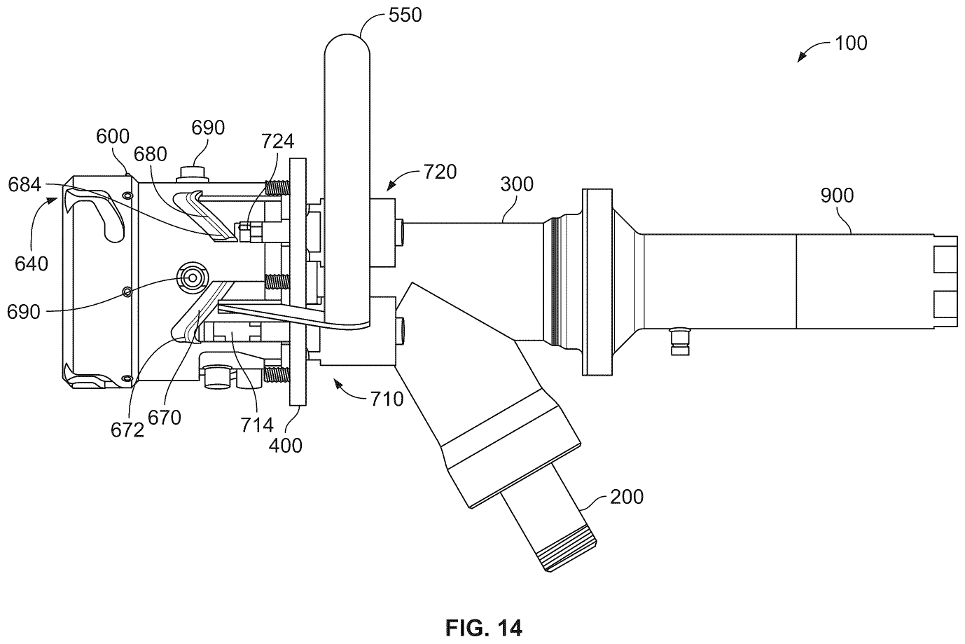

Each locking guide rail 670 extends helically in a first helical direction, and each unlocking guide rail 680 extends helically about body 610 of rotating sleeve 600 in an opposing second helical direction. Each locking guide rail 670 includes concave wall 676 that extends helically between a respective proximal end 672 and distal end 674 (relative to the outer edge of actuator end 630), and each unlocking guide rail 680 includes concave wall 686 that extends helically between a respective proximal end 682 and distal end 684 (relative to the outer edge of actuator end 630). Concave wall 676 of each locking guide rail 670 is configured to slidably receive ball bearing 716 of shaft 714 of a respective locking actuator 710 as rotating sleeve 700 transitions between its locked and unlocked positions. Similarly, concave wall 686 of each unlocking guide rail 680 is configured to slidably receive ball bearing 726 of shaft 724 of a respective unlocking actuator 720. As shown in FIGS. 9-14, shaft 714 of each locking actuator 710 extends into a respective cutout 650 and engages a respective guide rail 670, and shaft 724 of each unlocking actuator 720 extends into a respective cutout 660 and engages a respective guide rail 680.

To rotate rotating sleeve 700 to its locked position, each unlocking actuator 720 retracts its shaft 724 and each locking actuator 710 extends its shaft 714. The first helical direction of each locking guide rail 670 causes rotating sleeve 700 to rotate toward its locked position as shaft 714 of each locking actuator 710 extends and pushes against its locking guide rail 670. That is, locking guide rails 670 are configured to convert axial motion of shafts 714 of locking actuators 710 into a first helical motion of rotating sleeve 700. As rotating sleeve 700 rotates to its locked position, (1) ball bearing 716 of each shaft 714 slides along concave wall 676 to distal end 674 of its respective locking guide rail 670 and (2) ball bearing 726 of each shaft 724 slides along concave wall 686 to proximal end 682 of its respective unlocking guide rail 680.

Conversely, to rotate rotating sleeve 700 to its unlocked position, each locking actuator 710 retracts its shaft 714 and each unlocking actuator 720 extends its shaft 724. The second helical direction of each unlocking guide rail 680 causes rotating sleeve 700 to rotate toward its unlocked position as shaft 724 of each unlocking actuator 720 extends and pushes against its unlocking guide rail 680. That is, unlocking guide rails 680 are configured to convert axial motion of shafts 724 of unlocking actuators 720 into a second helical motion of rotating sleeve 700. As rotating sleeve 700 rotates to its unlocked position, (1) ball bearing 726 of each shaft 724 slides along concave wall 686 to distal end 684 of its respective unlocking guide rail 680 and (2) ball bearing 716 of each shaft 714 slides along concave wall 676 to proximal end 672 of its respective locking guide rail 670.

Returning to FIG. 7, body 610 of rotating sleeve 600 defines opening 615 arranged to provide access to purge inlet port 420 and purge outlet port 425 (FIGS. 10-12) that are that are fixed to ring flange 400. Rotating sleeve 600 also includes one or more posts 690 that extend from body 610 in a radially outward direction. Each post 690 extends through a respective slotted opening 560 of fixed sleeve 500 (FIG. 8) to fix rotating sleeve 1600 axially to fixed sleeve 500. In turn, fixed sleeve 500, ring flange 400, and flow body 200 move axially with rotating sleeve 600 relative to receptacle 50 as rotating sleeve 600 moves in a helical motion to lock nozzle 100 to receptacle 50.

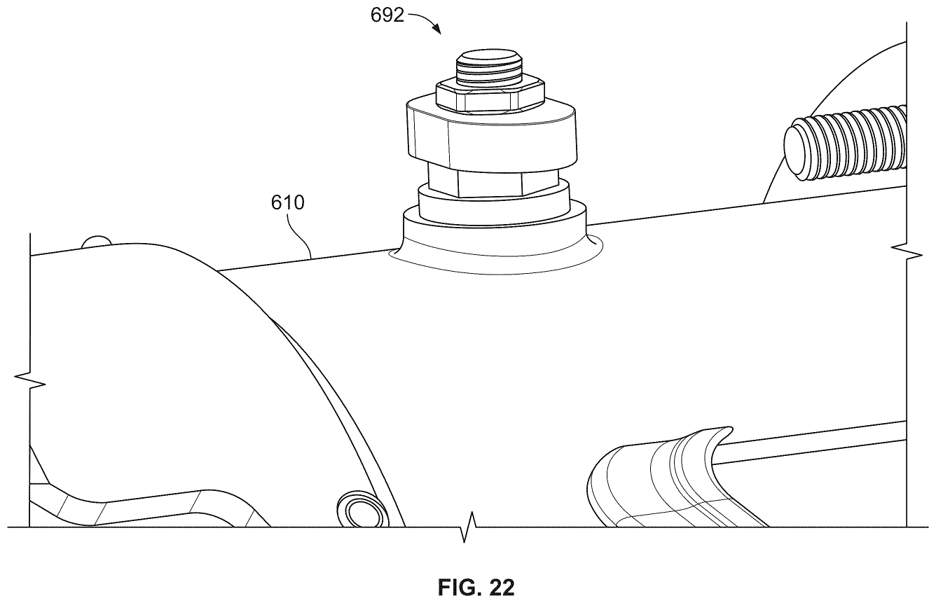

FIGS. 22-24 depict other example posts 692 as an alternative to posts 690. Similar to posts 690 of FIG. 7, posts 692 of FIGS. 22-24 extend from body 610 of rotating sleeve 600 in a radially outward direction and through a respective slotted opening 560 of fixed sleeve 500 (FIG. 8) to fix rotating sleeve 600 axially to fixed sleeve 500.

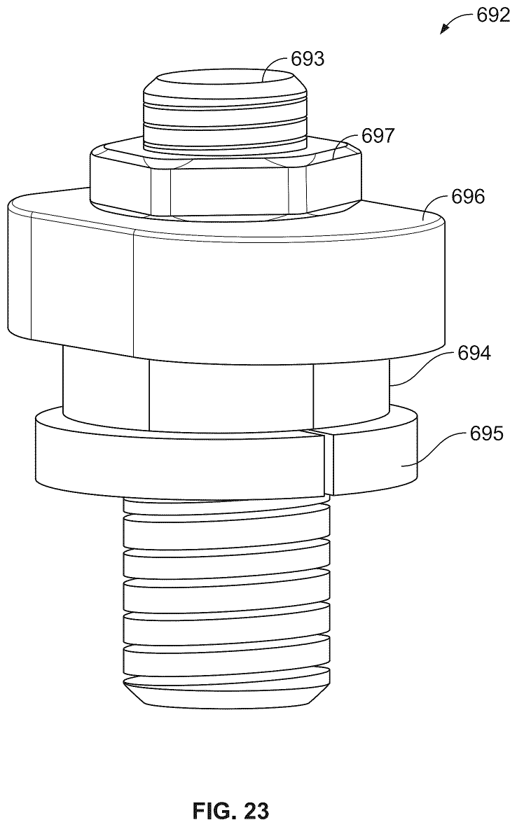

As shown in FIG. 23, post 692 includes threaded stem 693 that is threadably coupled to body 610 of rotating sleeve 600. Post 692 includes bearing 696 that is slidably received in a respective slotted opening 560 of fixed sleeve 500. Bearing 696 includes a through-hole through which threaded stem 693 extends when post 692 is assembled. In the illustrated example, bearing 696 is stadium-shaped to facilitate bearing 696 in sliding through a respective slotted opening 560. Further, post 692 includes nut 694 (also referred to as a “first nut” and an “adjusting nut”) that is configured to adjust a radial positioning of bearing relative to body 610 to radially align bearing 696 within a respective slotted opening 560. In the illustrated example, post 692 includes washer 695, which, as shown in FIG. 22, is positioned radially between and engage nut 694 and body 610 of rotating sleeve 600. Post 692 also includes nut 697 (also referred to as a “second nut” and a “securing nut”) that secures bearing 696 to threaded stem 693 and radially between nut 694 and nut 697. In the illustrated example, nut 697 is a panel nut.

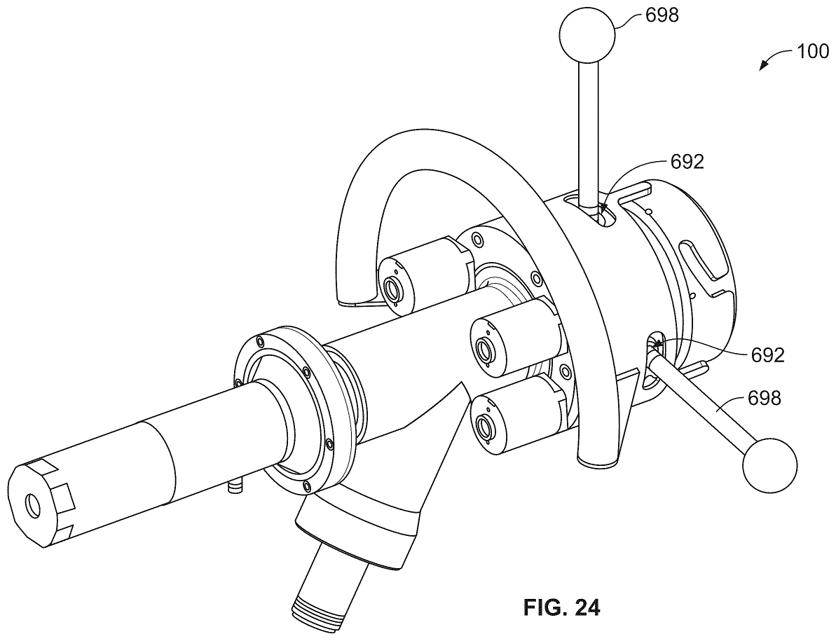

Turning to FIG. 24, one or more handles 698 may be used with respective posts 692. For example, handles 698 (also referred to as “coupling handles” and “manual coupling handles”) may be used to manually couple nozzle 100 to receptacle 50 and/or manually uncouple nozzle 100 from receptacle 50. To couple handle 698 to a respective post 692, nut 697 is removed from threaded stem 693 to increase an amount of threads to which internal threads of handle 698 may threadably couple to threaded stem 693. Handle 698 is then threadably coupled to an end of threaded stem 693. In the illustrated example, two handles 698 are coupled to two respective posts 692 to facilitate an operator in manipulating rotating sleeve 600 to couple nozzle 100 to receptacle 50 and/or uncouple nozzle 100 from receptacle 50.

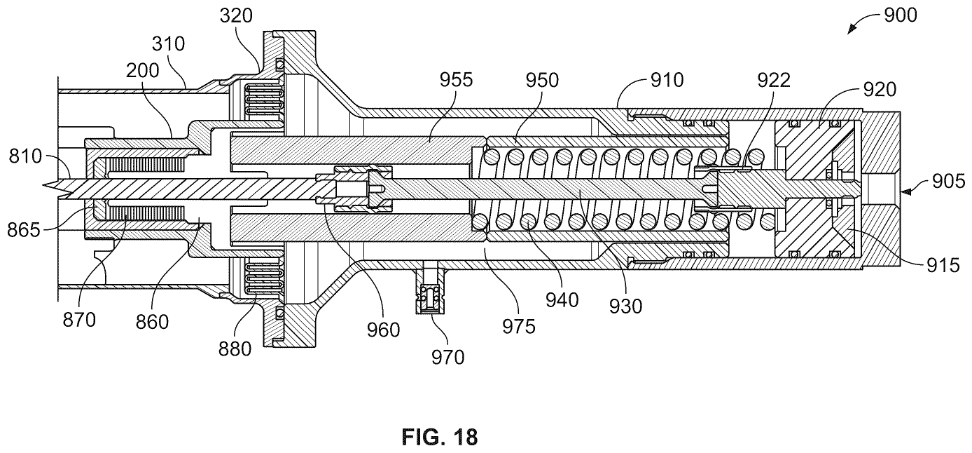

FIGS. 16-18 further depict flow body 200, shell 300, flow assembly 800, and actuator 900 of nozzle 100. Shell 300 extends over and circumferentially covers at least a portion of flow body 200. Insulation layer 305 is formed between flow body 200 and shell 300 and provides insulation between shell 300 and the extremely cold temperature of cryogenic fluid flowing through chamber 205 of flow body 200. In the illustrated example, shell 300 includes shell body 310, shell connector 320, and zig-zag walls 330. As shown in FIG. 18, shell connector 320 is configured to securely and sealingly couple to actuator 900 at the back end of nozzle 100. Shell body 310 is sealingly connected to shell connector 320 and extends toward the front end of nozzle 100. Zig-zag walls 330 are sealingly coupled to and extend between a front portion of flow body 200 and a front portion of shell body 310. Zig-zag walls 330 define insulation layer 305 with shell 300 and flow body 200. Zig-zag walls 330 extend longitudinally back-and-forth in a zig-zag pattern to form an elongated conduction path between chamber 205 and the exterior of nozzle 100 to reduce an amount of heat leak between chamber 205 and the exterior.

As shown in FIG. 17, flow assembly 800 includes stem 810, poppet 820, seat 830, and seal 840. Seat 830 positioned in chamber 205 and fixed to flow body 200 adjacent the front end of flow body 200. Seal 840 (also referred to as “cold seal” is fixed to an inner wall of seat 830. Stem 810 slidably extends through chamber 205 along the longitudinal axis of flow body 200. Stem 810 extends between and connects actuator 900 and poppet 820. Poppet 820 is coupled to a front end of stem 810. In the illustrated example, stem 810 includes main stem 812 and stem extender 814. Main stem 812 extends through a majority of chamber 205, and stem extender 814 is coupled to (e.g., threadably) and extends from a front end of main stem 812. Stem guide 816 engages both stem 810 and stem body 200 to guide stem 810 in an axial direction, thereby deterring misalignment of stem 810 and subsequent damage to seals. In FIG. 17, stem guide 816 extends over stem 810 at the connection point between main stem 812 and stem extender 814. Further, stem guide 816 is secured in place axially via retainer 818 and a flanged end of stem extends 814.

Poppet 820 defines face surface 822. As disclosed below in greater detail, face surface 822 of poppet 820 of nozzle 100 is configured to securely engage face surface 78 of poppet 70 of receptacle 50 prior to and during a fill event. Poppet 820 also is configured to sealingly engage seat 830 in a closed position to stop fluid flow through chamber 205 of nozzle 100 and be disengaged from seat in an open position to permit fluid flow through chamber 205. Actuator 900 is connected to stem 810 to linearly actuate poppet 820 between its closed position and its open position. Specifically, shaft 930 of actuator 900 is connected to a back end of stem 810 to cause stem 810 and, in turn, poppet 820 to actuate linearly.

FIG. 18 further depicts actuator 900 (also referred to as “flow-control actuator”). In the illustrated example, actuator 900 is a pneumatic actuator. Actuator 900 includes housing 910 (also referred to as “actuator housing” and “flow-control actuator housing”) that is securely and sealingly connected to flow body 200 and shell connector 320 of shell 300. Actuator 900 also includes piston 920, shaft 930, spring 940, and sleeve 950 (also referred to as “back sleeve” and “second sleeve”) that are housed in housing 910. Sleeve 955 (also referred to as “back sleeve” and “second sleeve”) and connector 960 are at least partially housed in housing 910.

Piston 920 is positioned at a back end of housing 910 adjacent to port 905. Shaft 930 extends between and connects piston 920 and stem 810. In the illustrated example, shaft 930 is coupled to piston 920 via connector 922 (e.g., a crimped connector) and is coupled to stem 810 via connector 960 (e.g., a crimped connector). Sleeve 950 and sleeve 955 are arranged axially in a side-by-side manner. Further, sleeves 950, 955 are arranged such that shaft 930 extends through sleeve 950 and at least partially into sleeve 955. Spring 940 extends between and engages sleeve 955 and piston 920 and is configured to bias piston 920 in a retracted position adjacent to port 905. To move piston 920 and, in turn, shaft 930 of actuator 900 to its extended position, pressurized fluid is provided in pressure chamber 915 via port 905. Additionally, actuator 900 includes vacuum port 970 that is coupled to housing 910 and is configured to form a vacuum in vacuum chamber 975 within housing 910.

FIG. 18 also shows a sealed and insulated connection between actuator 900 and flow body 200 and/or shell 300. In the illustrated example, nozzle 100 further includes stem guide 860, bellows flange 865, bellows 870 (also referred to as “bellows seal”), and zig-zag wall 880 (also referred to as “radial zig-zag wall”). Stem guide 860, bellows flange 865, and bellows 870 are housed in a back end of flow body 200, and stem 810 slidably extends through stem guide 860, bellows flange 865, and bellows 870. Bellows 870 is coupled to and extends between bellows flange 865 and stem guide 860 to form a seal therebetween. Zig-zag wall 880 is sealingly connected and extends radially between flow body 200 and shell connector 320 to form a seal therebetween.

FIG. 19 depicts nozzle 100 in a purge state relative to receptacle 50. In the illustrated example, a gap is formed between face surface 78 of poppet 70 of receptacle 50 and face surface 822 of poppet 820 of nozzle 100.

To position nozzle 100 in the purge state, axial pins 540 of fixed sleeve 500 of nozzle 100 are inserted into respective axial slots 96 of receptacle 50 to rotationally fix fixed sleeve 500 and flow body 200 of nozzle 100 relative to receptacle 50. Further, teeth 98 of receptacle 50 are inserted into front portion 642 of respective cam slots 640 of rotating sleeve 600 of nozzle 100. Detents 625 of rotating sleeve 600 are configured to securely retain nozzle 100 and receptacle 50 in the purge state prior to rotation of rotating sleeve 600. In the purge state, coupling chamber 150 is formed between nozzle 100 and receptacle 50. Purge inlet port 420 and purge outlet port 425 are fluidly connected to coupling chamber 150 via purge channel 155. Purge inlet port 420 and purge outlet port 425 are configured to purge unwanted gas(es) and/or debris from coupling chamber 150 when nozzle 100 is in the purge state. After coupling chamber 150 has been purged, nozzle 100 is transitioned to its locked position.

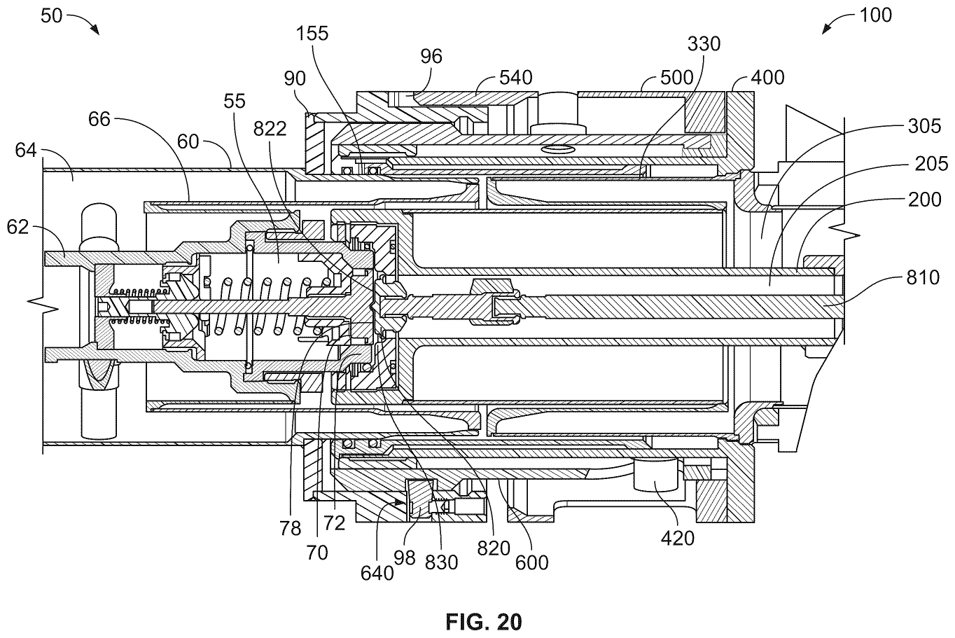

FIG. 20 depicts nozzle 100 in a locked state with receptacle 50. In the locked state, head 72 of receptacle 50 sealingly engages seat 830 of nozzle 100 via seal 840. Further, face surface 78 of poppet 70 of receptacle 50 securely engages face surface 822 of poppet 820 of nozzle 100. In turn, poppets 70, 80 of receptacle 50 are able to open upon poppet 820 of nozzle 100 of opening.

To position nozzle 100 in its locked state, rotating sleeve 600 is rotated via actuators 710 to its locked position. As rotating sleeve 600 rotates, teeth 98 of receptacle 50 slide along rear portion 644 of respective cam slots 640. The helical shape of cam slots 640 also causes rotating sleeve 600 to slide axially toward receptacle 50. Further, posts 690 of rotating sleeve 600 pull fixed sleeve 500 and, in turn, flow body 200 toward receptacle 50. When rotating sleeve 600 has been rotated fully to its locked position, the gap between face surface 78 of poppet 70 and face surface 822 of poppet 820 has closed such that poppet 820 of nozzle 100 engages poppet 70 of receptacle 50.

Once nozzle 100 is placed in a locked state with receptacle 50, a fill event may commence by actuating shaft 930 of actuator 900 to its extended position. Shaft 930 pushes stem 810, which causes poppet 820 to disengage from seat 830. When poppet 820 transitions to its open position, it pushes poppet 70 to disengage from its seat. Cryogenic fluid flows into the portion of chamber 55 of receptacle between poppets 70, 80. Poppet 80 initially remains closed due to a pressure difference and opens once pressure is equalized. When poppet 820 of nozzle 100 and poppets 70, 80 of receptacle 50 are in their respective open positions, fluid is able to flow through nozzle 100 and receptacle 50 for the fill event.

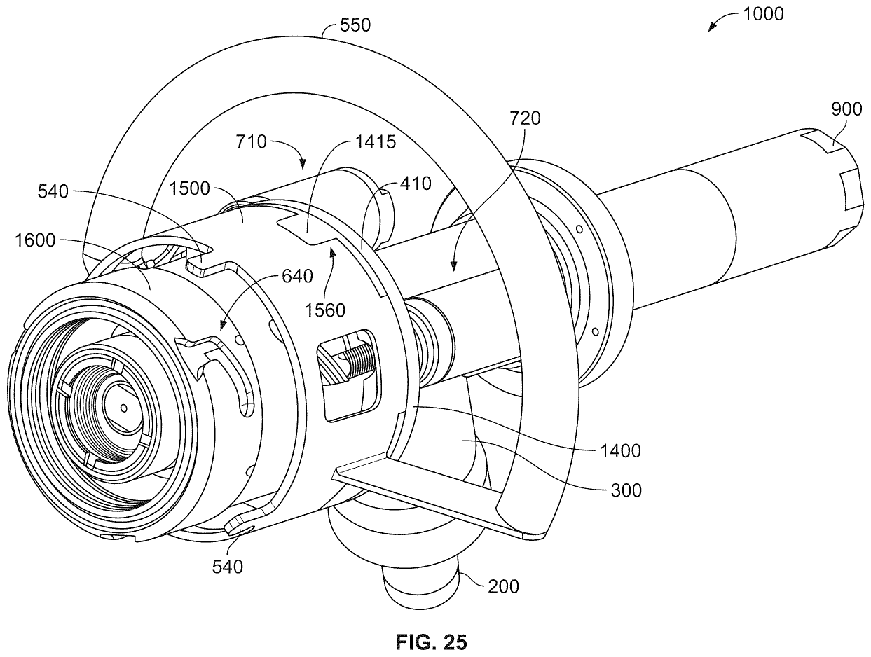

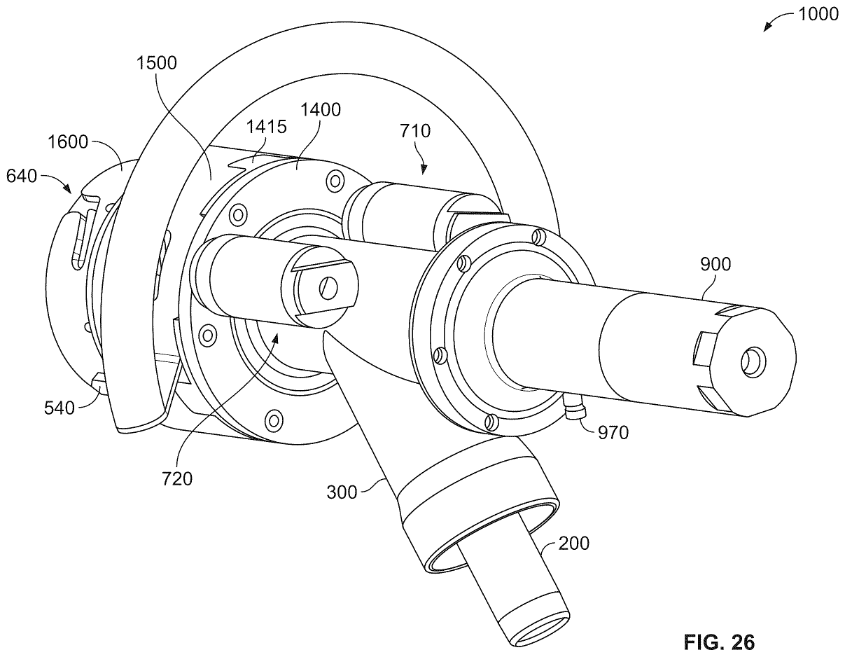

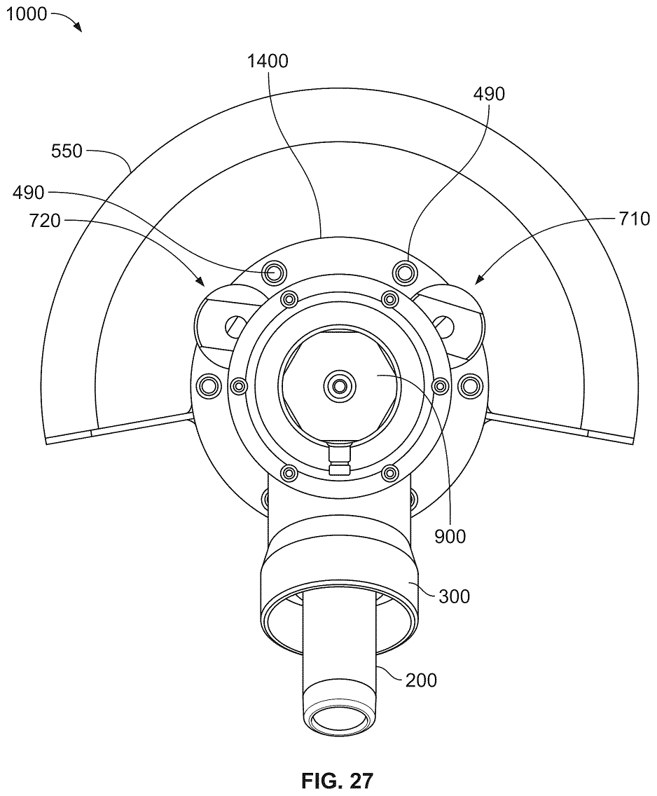

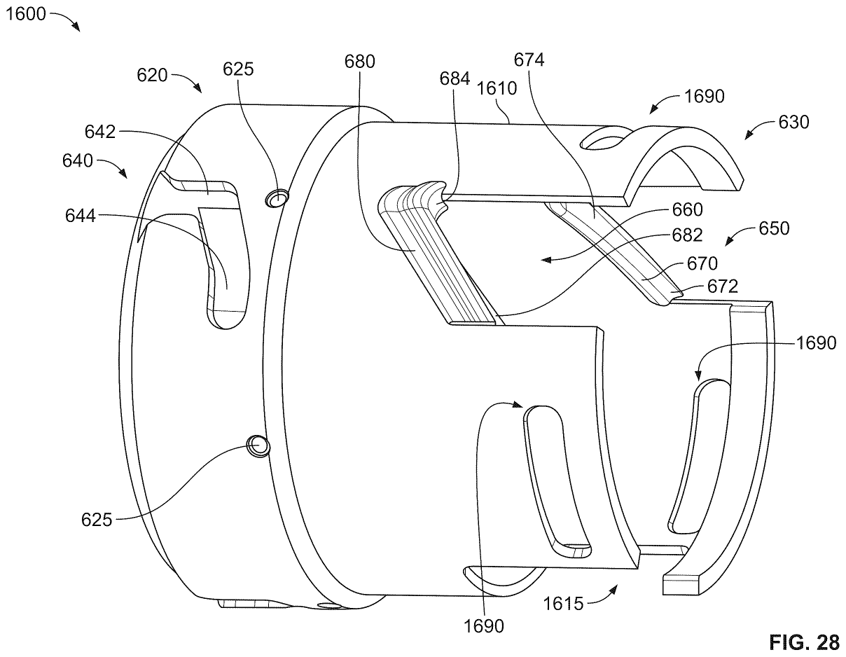

FIGS. 25-27 depict another example nozzle 1000, and FIG. 28 depicts rotating sleeve 1600 of nozzle 1000. Nozzle 1000 of FIGS. 25-27 includes many components that are identical and/or substantially similar to those of nozzle 100 of FIGS. 3-14 and 16-24. For example, flow body 200; shell 300; actuators 710, 720; flow assembly 800; and actuator 900 of FIGS. 25-27 are identical and/or substantially similar to those of FIGS. 3-14 and 16-24. Further, because those elements have been disclosed in detail with respect to FIGS. 3-14 and 16-24, those elements are not described again for concision with respect to nozzle 1000 of FIGS. 25-28 unless otherwise indicated below. Instead, only elements of nozzle 1000 that are new or modified with respect to nozzle 100, such as ring flange 1400, fixed sleeve 1500, and rotating sleeve 1600, are further detailed below.

As shown in FIGS. 25-27, nozzle 1000 includes one locking actuator 710 to rotate rotating sleeve 1600 to its locked position and one unlocking actuator 720 to rotate rotating sleeve 1600 to its unlocked position.

Turning to FIG. 28, rotating sleeve 1600 includes many components that are identical and/or substantially similar to those of rotating sleeve 600 of FIG. 7. For example, cam slots 640; cutouts 650, 660; and guide rails 670, 680 of FIG. 28 are identical and/or substantially similar to those of FIG. 7. Further, because those elements have been disclosed in detail with respect to FIG. 7, those elements are not described again for concision with respect to rotating sleeve 1600 of FIG. 28 unless otherwise indicated below. Instead, only elements of rotating sleeve 1600 that are new or modified with respect to rotating sleeve 600 are further detailed below.

In the illustrated example, rotating sleeve 1600 includes body 1610 that has coupling end 620 and actuator end 630. Along actuator end 630, body 1610 defines one locking cutout 650 for one locking actuator 710 and defines one unlocking cutout 660 for one unlocking actuator 720. Rotating sleeve 1600 also includes one locking guide rail 670 for shaft 714 of the one locking actuator 710 and includes one unlocking guide rail 680 for shaft 724 of the one unlocking actuator 720.

Further, body 1610 of rotating sleeve 1600 define one or more slotted openings 1690. Each slotted opening 1690 adjacent and spaced apart from actuator end 630 of body 1610. Further, each slotted opening 1690 extends circumferentially about rotating sleeve 1600 in a direction parallel to an outer edge at actuator end 630 of body 1610. Each slotted opening 1690 is configured to receive a respective post 1415 of ring flange 1400.

As shown in FIG. 25, posts 1415 extend from radial portion 410 of ring flange 1400 in a radially inward direction. Each post 1415 extends through a respective cutout 1560 of fixed sleeve 1500 and through a respective slotted opening 1690 to fix rotating sleeve 1600 axially to fixed sleeve 1500, ring flange 1400, and flow body 200. In turn, fixed sleeve 1500 and flow body 200 move axially with rotating sleeve 1600 relative to receptacle 50 as rotating sleeve 1600 moves in a helical motion to lock nozzle 1000 to receptacle 50.

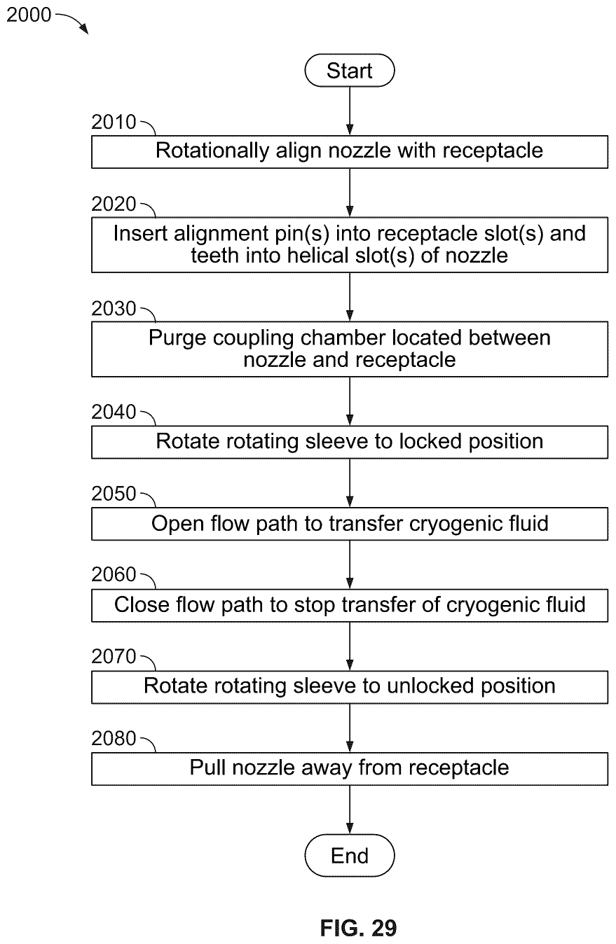

Turning to FIG. 29, a flowchart of example method 2000 for operating nozzle 100, 1000 with receptacle 50 is depicted. Because method 2000 is disclosed in connection with the components of FIGS. 1-28, some functions of those components will not be described in detail below.

At block 2010, operator 40 rotationally aligns nozzle 100, 1000 with receptacle 50 such that axial pins 540 of nozzle 100, 1000 are positioned in front of and align axially with axial slots 96 of receptacle 50. Operator 40 moves nozzle 100, 1000 and receptacle 50 axially toward each other while maintaining the rotational alignment between nozzle 100, 1000 and receptacle 50. At block 2020, axial pins 540 of fixed sleeve 500 of nozzle 100, 1000 are inserted into respective axial slots 96 of receptacle 50 to rotationally fix fixed sleeve 500 and flow body 200 of nozzle 100, 1000 relative to receptacle 50. Additionally, teeth 98 of receptacle 50 are inserted into front portion 642 of respective cam slots 640 of rotating sleeve 600, 1600 of nozzle 100, 1000.

At block 2030, a purge sequence is performed for coupling chamber 150 formed between nozzle 100, 1000 and receptacle 50. For example, while teeth 98 of receptacle 50 remain positioned in front portion 642 of respective cam slots 640, operator 40 initiates (e.g., via a control system at filling station 20) pressurized fluid to be fed into purge inlet port 420, through coupling chamber 150, and out of purge outlet port 425 to purge unwanted gas(es) and/or debris from coupling 135, 1135 chamber prior to a fill event.

At block 2040, rotating sleeve 600, 1600 of nozzle 100, 1000 is rotated from an unlocked position to a locked position to securely lock nozzle 100, 1000 to receptacle 50. To rotate rotating sleeve 600, 1600 to its locked position, shaft(s) 724 of actuator(s) 720 are retracted and shaft(s) 714 of actuator(s) 710 are concurrently and/or simultaneously extended. Shaft(s) 714 of actuator(s) 710 cause rotating sleeve 600 to rotate and slide axially forward in a first helical motion. In turn, teeth 98 of receptacle 50 slide along rear portions 644 of respective cam slots 640 of rotating sleeve 600 and to distal ends of those cam slots 640. Shaft(s) 714 of actuator(s) 710 remain extended to lock to nozzle 100, 1000 and receptacle 50 together. Operator 40 may initiate rotation of rotating sleeve 600, 1600 via a control system (e.g., at filling station 20).

At block 2050, when nozzle 100, 1000 and receptacle 50 are in securely locked together, the flow path between nozzle 100, 1000 and receptacle 50 is opened to permit cryogenic fluid to be transferred through nozzle 100, 1000 and receptacle 50 during a fill event. To open the flow path, shaft 930 actuator 900 is actuated to an extended position to cause poppet 802 of nozzle 100, 1000 and poppets 70, 80 of receptacle 50 to move to their respective open positions. Operator 40 may initiate the opening of the flow path via a control system (e.g., at filling station 20). A fill event is performed while the flow path between nozzle 100, 1000 and receptacle 50 is open.

Block 2060 after the fill event has been completed. At block 2060, the flow path between nozzle 100, 1000 and receptacle 50 is closed to stop the cryogenic fluid from being transferred through nozzle 100, 1000 and receptacle 50. To close the flow path, shaft 930 actuator 900 is actuated to a retracted position to cause poppet 802 of nozzle 100, 1000 and poppets 70, 80 of receptacle 50 to move to their respective closed positions. Operator 40 may initiate the closing of the flow path via a control system (e.g., at filling station 20).

At block 2070, rotating sleeve 600, 1600 of nozzle 100, 1000 is rotated from its locked position to its unlocked position. To return rotating sleeve 600, 1600 to its unlocked position, shaft(s) 714 of actuator(s) 710 are retracted and shaft(s) 724 of actuator(s) 720 are concurrently and/or simultaneously extended. Shaft(s) 724 of actuator(s) 710 cause rotating sleeve 600 to rotate and slide axially backward in a second helical motion. In turn, teeth 98 of receptacle 50 slide along rear portions 644 of respective cam slots 640 of rotating sleeve 600 and to respective front portions 642 of those cam slots 640. Operator 40 may initiate rotation of rotating sleeve 600, 1600 via a control system (e.g., at filling station 20).

At block 2080, operator 40 nozzle 100, 1000 axially away from receptacle 50 to decouple nozzle 100, 1000 from receptacle. As operator 40 pulls nozzle 100, 1000 away from receptacle 50 axial pins 540 of nozzle 100, 1000 slide out of axial slots 96 of receptacle 50 and teeth 98 of receptacle 50 slide out of front portion 642 of respective cam slots 640 to decouple nozzle 100, 1000 from receptacle 50.

Exemplary embodiments in accordance with the teachings herein are disclosed below.

Embodiment 1. A nozzle for coupling and providing fluid to a receptacle includes a flow body defining a chamber for fluid flow and including a front end and a back end. The nozzle includes a rotating sleeve configured to rotate about the front end of the flow body. The rotating sleeve includes a coupling end adjacent the front end of the flow body and defining one or more cam slots. The one or more cam slots are configured to slidably receive respective one or more teeth of the receptacle as the rotating sleeve is rotated from an unlocked position to a locked position. The rotating sleeve includes an actuator end defining a plurality of cutouts. The actuator end includes a plurality of helical guide rails. Each of the plurality of helical guide rails is located at an innermost wall defining a respective one of the plurality of cutouts. The nozzle includes a plurality of locking/unlocking actuators each of which includes an actuator housing fixed relative to the flow body and a shaft extending into a respective one of the plurality of cutouts. The shaft is configured to engage and push against a respective one of the plurality of helical guide rails to cause the rotating sleeve to rotate between the unlocked position and the locked position.

Embodiment 2. The nozzle of Embodiment 1, further including a ring flange fixed relative to the flow body. The ring flange extends circumferentially around a portion of and is coaxial with the flow body.

Embodiment 3. The nozzle of Embodiment 2, wherein the ring flange includes an axial portion coaxial with the flow body and a radial portion that extends radially outward from the flow body.

Embodiment 4. The nozzle of Embodiment 2 or 3, wherein each of the plurality of locking/unlocking actuators includes an actuator housing coupled to the ring flange.

Embodiment 5. The nozzle of any of Embodiments 1-4, wherein the plurality of cutouts are arranged circumferentially about the actuator end of the rotating sleeve.

Embodiment 6. The nozzle of any of Embodiments 1-5, wherein the rotating sleeve includes a sleeve body. The plurality of helical guide rails are coupled to the sleeve body.

Embodiment 7. The nozzle of any of Embodiments 1-6, wherein the shaft of each of the plurality of locking/unlocking actuators includes a distal end and a ball bearing at the distal end. Each of the plurality of helical guide rails includes a concave wall configured to slidably receive the ball bearing of a respective one of the plurality of locking/unlocking actuators.

Embodiment 8. The nozzle of any of Embodiments 1-7, wherein the shaft of each of the plurality of locking/unlocking actuators moves linearly in a direction parallel to a longitudinal axis extending between the front end and the back end of the flow body.

Embodiment 9. The nozzle of any of Embodiments 1-8, wherein the plurality of locking/unlocking actuators are pneumatic actuators.

Embodiment 10. The nozzle of any of Embodiments 1-9, wherein the plurality of locking/unlocking actuators are arranged circumferentially about the flow body.

Embodiment 11. The nozzle of any of Embodiments 1-10, wherein the plurality of locking/unlocking actuators include one or more locking actuators and one or more unlocking actuators.

Embodiment 12. The nozzle of Embodiment 11, wherein the shaft of each of the one or more locking actuators is configured to extend to push the rotating sleeve to the locked position and slide to a distal end of a respective one of the plurality of helical guide rails and retract to permit the rotating sleeve to return to the unlocked position and slide to a proximal end of a respective one of the plurality of helical guide rails.

Embodiment 13. The nozzle of Embodiment 11 or 12, wherein the shaft of each of the one or more unlocking actuators is configured to extend to push the rotating sleeve to the unlocked position and slide to a distal end of a respective one of the plurality of helical guide rails and retract to permit the rotating sleeve to return to the locked position and slide to a proximal end of a respective one of the plurality of helical guide rails.

Embodiment 14. The nozzle of any of Embodiments 11-13, wherein each the plurality of helical guide rails corresponding with the one or more locking actuators extends in a first helical direction. Each the plurality of helical guide rails corresponding with the one or more unlocking actuators extends in a second helical direction. The second helical direction is opposite the first helical direction.

Embodiment 15. The nozzle of any of Embodiments 11-14, wherein the plurality of locking/unlocking actuators are equidistantly spaced apart from each other about the flow body. The one or more locking actuators and the one or more unlocking actuators are arranged in an alternating manner.

Embodiment 16. The nozzle of any of Embodiments 11-15, wherein the one or more locking actuators include two opposing locking actuators and the one or more unlocking actuators include two opposing unlocking actuators.

Embodiment 17. The nozzle of any of Embodiments 1-16, further including an outer shell that extends over and circumferentially covers at least a portion of the flow body and an insulation layer formed between the flow body and the outer shell.

Embodiment 18. The nozzle of any of Embodiments 1-17, further including a fixed sleeve extending circumferentially around a portion of the rotating sleeve. The fixed sleeve is fixed relative to the flow body.

Embodiment 19. The nozzle of Embodiment 18, wherein the fixed sleeve includes one or more axial pins that are configured to be slidably received by respective one or more axial slots of the receptacle to rotatably fix the flow body to the receptacle.

Embodiment 20. The nozzle of Embodiment 18 or 19, wherein the fixed sleeve includes a handle for an operator.

Embodiment 21. The nozzle of any of Embodiments 18-20, wherein the fixed sleeve defines one or more slotted openings and the rotating sleeve includes one or more posts. Each of the one or more posts extends radially through a respective one of the one or more slotted openings to cause the fixed sleeve and the flow body to move axially with the rotating sleeve relative to the receptacle.

Embodiment 22. The nozzle of Embodiment 21, wherein each of the one or more posts includes a threaded stem threadably coupled to a sleeve body of the rotating sleeve, a bearing slidably received in a respective one of the slotted openings of the fixed sleeve, a first nut configured to adjust a radial positioning of the bearing relative to the sleeve body, and a second nut configured to secure the bearing to the threaded stem radially between the first nut and the second nut.

Embodiment 23. The nozzle of any of Embodiments 18-20, further including one or more posts fixed relative to the flow body. The rotating sleeve defines one or more slotted openings. Each of the one or more posts extends radially through a respective one of the one or more slotted openings to cause the flow body to move axially with the rotating sleeve relative to the receptacle.

Embodiment 24. The nozzle of any of Embodiments 1-23, wherein each of the one or more cam slots includes a front portion extending axially along the rotating sleeve and a rear portion extending from the front portion and helically about the rotating sleeve.

Embodiment 25. The nozzle of any of Embodiments 1-24, further including a purge inlet port and a purge outlet port configured to fluidly connect to a coupling chamber formed between the nozzle and the receptacle to purge at least one of unwanted gas or debris from the coupling chamber prior to a fill event.

Embodiment 26. The nozzle of Embodiment 25, wherein the purge inlet port includes a restrictor defining an orifice to limit a flowrate into the coupling chamber and a screen upstream of the restrictor to filter out debris from a purge gas supply.

Embodiment 27. The nozzle of Embodiment 25 or 26, wherein the purge inlet port and the purge outlet port are configured to purge at least one of unwanted gas or debris from the coupling chamber when each of the one or more teeth of the receptacle is received by a front portion of a respective one of the one or more cam slots.

Embodiment 28. The nozzle of any of Embodiments 24-27, further including a stem extending though the chamber of the flow body, a seat positioned in the chamber adjacent the front end of the flow body, and a poppet coupled to the stem in the chamber. The poppet is configured to engage the seat in a closed position and be disengaged from the seat in an open position.

Embodiment 29. The nozzle of Embodiment 28, further including a flow-control actuator connected to the stem to linearly actuate the poppet between the closed position and the open position.

Embodiment 30. The nozzle of Embodiment 29, wherein the flow-control actuator is a pneumatic actuator.

Embodiment 31. The nozzle of any of Embodiments 28-30, wherein, prior to a fill event, the poppet of the nozzle is configured to engage an outer poppet of the receptacle when the rotating sleeve is rotated to cause each of the one or more teeth of the receptacle to be positioned at a distal end of the rear portion of a respective one of the one or more cam slots.

Embodiment 32. A nozzle for coupling and providing fluid to a receptacle includes a flow body defining a chamber for fluid flow and including a front end and a back end and a rotating sleeve configured to rotate about the front end of the flow body. The rotating sleeve defines one or more cam slots configured to slidably receive respective one or more teeth of the receptacle as the rotating sleeve is rotated from an unlocked position to a locked position. The nozzle includes a fixed sleeve extending circumferentially around a portion of the rotating sleeve and fixed relative to the flow body. The fixed sleeve includes one or more axial pins that are configured to be slidably received by respective one or more axial slots of the receptacle to rotatably fix the flow body to the receptacle. The nozzle includes a purge inlet port and a purge outlet port configured to fluidly connect to a coupling chamber formed between the nozzle and the receptacle to purge at least one of unwanted gas or debris from the coupling chamber prior to a fill event. The purge inlet port includes a restrictor defining an orifice to limit a flowrate into the coupling chamber and a screen upstream of the restrictor to filter out debris from a purge gas supply.

Embodiment 33. The nozzle of Embodiment 32, further including a ring flange fixed relative to the flow body. The ring flange extends circumferentially around a portion of and is coaxial with the flow body.

Embodiment 34. The nozzle of Embodiment 33, wherein the ring flange includes an axial portion coaxial with the flow body and a radial portion that extends radially outward from the flow body.

Embodiment 35. The nozzle of any of Embodiments 32-34, further including an outer shell that extends over and circumferentially covers at least a portion of the flow body and an insulation layer formed between the flow body and the outer shell.

Embodiment 36. The nozzle of any of Embodiments 32-35, wherein the fixed sleeve includes a handle for an operator.

Embodiment 37. The nozzle of any of Embodiments 32-36, wherein the fixed sleeve defines one or more slotted openings and the rotating sleeve includes one or more posts. Each of the one or more posts extends radially through a respective one of the one or more slotted openings to cause the fixed sleeve and the flow body to move axially with the rotating sleeve relative to the receptacle.

Embodiment 38. The nozzle of Embodiment 37, wherein each of the one or more posts includes a threaded stem threadably coupled to a sleeve body of the rotating sleeve, a bearing slidably received in a respective one of the slotted openings of the fixed sleeve, a first nut configured to adjust a radial positioning of the bearing relative to the sleeve body, and a second nut configured to secure the bearing to the threaded stem radially between the first nut and the second nut.

Embodiment 39. The nozzle of any of Embodiments 32-38, further including one or more posts fixed relative to the flow body. The rotating sleeve defines one or more slotted openings. Each of the one or more posts extends radially through a respective one of the one or more slotted openings to cause the flow body to move axially with the rotating sleeve relative to the receptacle.

Embodiment 40. The nozzle of any of Embodiments 32-39, wherein each of the one or more cam slots includes a front portion extending axially along the rotating sleeve and a rear portion extending from the front portion and helically about the rotating sleeve.

Embodiment 41. The nozzle of Embodiment 40, wherein the purge inlet port and the purge outlet port are configured to purge at least one of unwanted gas or debris from the coupling chamber when each of the one or more teeth of the receptacle is received by the one or more cam slots.

Embodiment 42. The nozzle of Embodiment 40 or 41, further including a stem extending though the chamber of the flow body, a seat positioned in the chamber adjacent the front end of the flow body, and a poppet coupled to the stem in the chamber. The poppet is configured to engage the seat in a closed position and be disengaged from the seat in an open position.

Embodiment 43. The nozzle of Embodiment 42, further including a flow-control actuator connected to the stem to linearly actuate the poppet between the closed position and the open position.

Embodiment 44. The nozzle of Embodiment 43, wherein the flow-control actuator is a pneumatic actuator.

Embodiment 45. The nozzle of any of Embodiments 42-44, wherein, prior to a fill event, the poppet of the nozzle is configured to engage an outer poppet of the receptacle when the rotating sleeve is rotated to cause each of the one or more teeth of the receptacle to be positioned at a distal end of the rear portion of a respective one of the one or more cam slots.

What is claimed is:

1. A nozzle for coupling and providing fluid to a receptacle, the nozzle comprising:
a flow body defining a chamber for fluid flow and including a front end and a back end;
a rotating sleeve configured to rotate about the front end of the flow body, wherein the rotating sleeve includes:
a coupling end adjacent the front end of the flow body and defining one or more cam slots, wherein the one or more cam slots are configured to slidably receive respective one or more teeth of the receptacle as the rotating sleeve is rotated from an unlocked position to a locked position; and
an actuator end defining a plurality of cutouts, wherein the actuator end includes a plurality of helical guide rails, wherein each of the plurality of helical guide rails is located at an innermost wall defining a respective one of the plurality of cutouts; and
a plurality of locking/unlocking actuators each of which includes:
an actuator housing fixed relative to the flow body; and
a shaft extending into a respective one of the plurality of cutouts, wherein the shaft is configured to engage and push against a respective one of the plurality of helical guide rails to cause the rotating sleeve to rotate between the unlocked position and the locked position.

2. The nozzle of claim 1, further comprising a ring flange fixed relative to the flow body, wherein the ring flange extends circumferentially around a portion of and is coaxial with the flow body, and wherein each of the plurality of locking/unlocking actuators includes an actuator housing coupled to the ring flange.

3. The nozzle of claim 1, wherein the plurality of cutouts and the plurality of locking/unlocking actuators are arranged circumferentially about the actuator end of the rotating sleeve.

4. The nozzle of claim 1, wherein the shaft of each of the plurality of locking/unlocking actuators includes a distal end and a ball bearing at the distal end, and wherein each of the plurality of helical guide rails includes a concave wall configured to slidably receive the ball bearing of a respective one of the plurality of locking/unlocking actuators.

5. The nozzle of claim 1, wherein the shaft of each of the plurality of locking/unlocking actuators moves linearly in a direction parallel to a longitudinal axis extending between the front end and the back end of the flow body.

6. The nozzle of claim 1, wherein the plurality of locking/unlocking actuators are pneumatic actuators.

7. The nozzle of claim 1, wherein the plurality of locking/unlocking actuators include one or more locking actuators and one or more unlocking actuators.

8. The nozzle of claim 7, wherein the shaft of each of the one or more locking actuators is configured to:
extend to push the rotating sleeve to the locked position and slide to a distal end of a respective one of the plurality of helical guide rails; and
retract to permit the rotating sleeve to return to the unlocked position and slide to a proximal end of a respective one of the plurality of helical guide rails.

9. The nozzle of claim 7, wherein the shaft of each of the one or more unlocking actuators is configured to:
extend to push the rotating sleeve to the unlocked position and slide to a distal end of a respective one of the plurality of helical guide rails; and
retract to permit the rotating sleeve to return to the locked position and slide to a proximal end of a respective one of the plurality of helical guide rails.

10. The nozzle of claim 7, wherein each the plurality of helical guide rails corresponding with the one or more locking actuators extends in a first helical direction, wherein each the plurality of helical guide rails corresponding with the one or more unlocking actuators extends in a second helical direction, wherein the second helical direction is opposite the first helical direction.

11. The nozzle of claim 7, wherein the plurality of locking/unlocking actuators are equidistantly spaced apart from each other about the flow body, and wherein the one or more locking actuators and the one or more unlocking actuators are arranged in an alternating manner.

12. The nozzle of claim 1, further comprising a fixed sleeve extending circumferentially around a portion of the rotating sleeve, wherein the fixed sleeve is fixed relative to the flow body, and wherein the fixed sleeve includes one or more axial pins that are configured to be slidably received by respective one or more axial slots of the receptacle to rotatably fix the flow body to the receptacle.

13. The nozzle of claim 12, wherein the fixed sleeve defines one or more slotted openings and the rotating sleeve includes one or more posts, wherein each of the one or more posts extends radially through a respective one of the one or more slotted openings to cause the fixed sleeve and the flow body to move axially with the rotating sleeve relative to the receptacle.

14. The nozzle of claim 13, wherein each of the one or more posts includes:
a threaded stem threadably coupled to a sleeve body of the rotating sleeve;
a bearing slidably received in a respective one of the slotted openings of the fixed sleeve;
a first nut configured to adjust a radial positioning of the bearing relative to the sleeve body; and
a second nut configured to secure the bearing to the threaded stem radially between the first nut and the second nut.

15. The nozzle of claim 12, further comprising one or more posts fixed relative to the flow body, wherein the rotating sleeve defines one or more slotted openings, wherein each of the one or more posts extends radially through a respective one of the one or more slotted openings to cause the flow body to move axially with the rotating sleeve relative to the receptacle.

16. The nozzle of claim 1, further comprising a purge inlet port and a purge outlet port configured to fluidly connect to a coupling chamber formed between the nozzle and the receptacle to purge at least one of unwanted gas or debris from the coupling chamber prior to a fill event.

17. A nozzle for coupling and providing fluid to a receptacle, the nozzle comprising:
a flow body defining a chamber for fluid flow and including a front end and a back end;
a rotating sleeve configured to rotate about the front end of the flow body, wherein the rotating sleeve defines one or more cam slots configured to slidably receive respective one or more teeth of the receptacle as the rotating sleeve is rotated from an unlocked position to a locked position;
a fixed sleeve extending circumferentially around a portion of the rotating sleeve and fixed relative to the flow body, wherein the fixed sleeve includes one or more axial pins that are configured to be slidably received by respective one or more axial slots of the receptacle to rotatably fix the flow body to the receptacle; and
a purge inlet port and a purge outlet port configured to fluidly connect to a coupling chamber formed between the nozzle and the receptacle to purge at least one of unwanted gas or debris from the coupling chamber prior to a fill event, wherein the purge inlet port includes:
a restrictor defining an orifice to limit a flowrate into the coupling chamber; and a screen upstream of the restrictor to filter out debris from a purge gas supply.

18. The nozzle of claim 17, wherein the fixed sleeve defines one or more slotted openings and the rotating sleeve includes one or more posts, wherein each of the one or more posts extends radially through a respective one of the one or more slotted openings to cause the fixed sleeve and the flow body to move axially with the rotating sleeve relative to the receptacle.

19. The nozzle of claim 17, further comprising one or more posts fixed relative to the flow body, wherein the rotating sleeve defines one or more slotted openings, wherein each of the one or more posts extends radially through a respective one of the one or more slotted openings to cause the flow body to move axially with the rotating sleeve relative to the receptacle.

20. The nozzle of claim 17, wherein the purge inlet port and the purge outlet port are configured to purge at least one of unwanted gas or debris from the coupling chamber when each of the one or more teeth of the receptacle is received by a front portion of a respective one of the one or more cam slots.
